(19) United States
(12) Patent Application Publication
(10) Pub. No.: US 2025/0106872 A1
(43) Pub. Date: Mar. 27, 2025

(54) SIDELINK CHANNELS FOR A SIDELINK SYSTEM OPERATING IN AN UNLICENSED BAND

(71) Applicant: Intel Corporation, Santa Clara, CA (US)

(72) Inventors: Kilian Roth, Munich (DE); Salvatore Talarico, Santa Clara, CA (US); Alexey Khoryaev, Santa Clara, CA (US); Sergey Panteleev, Kildare (IE); Mikhail Shilov, Santa Clara, CA (US)

(21) Appl. No.: 18/833,815

(22) PCT Filed: Apr. 20, 2023
(86) PCT No.: PCT/US2023/066001

§ 371 Date: Jul. 26, 2024

Related U.S. Application Data
(60) Provisional application No. 63/334,013, filed on Apr. 22, 2022.
(60) Provisional application No. 63/336,040, filed on Apr. 28, 2022.
(60) Provisional application No. 63/352,905, filed on Jun. 16, 2022.
(60) Provisional application No. 63/407,418, filed on Sep. 16, 2022.

(51) Int. Cl. H04W 72/25; H04L 5/00; H04W 72/0446

(52) U.S. Cl. CPC H04W 72/25; H04L 5/0007; H04L 5/0051; H04W 72/0446

(57) ABSTRACT

Various embodiments herein are related to new radio (NR) sidelink (SL) operation in the unlicensed spectrum. Specifically, various embodiments may relate to design parameters or implementations of a physical SL control channel (PSCCH) and/or physical SL shared channel (PSSCH) in such a network. Other embodiments may be described and/or claimed.

### CROSS REFERENCE TO RELATED APPLICATION

The present application claims priority to U.S. Provisional Patent Application No. 63/334,013, which was filed Apr. 22, 2022; U.S. Provisional Patent Application No. 63/336,040, which was filed Apr. 28, 2022; U.S. Provisional Patent Application No. 63/352,905, which was filed Jun. 16, 2022; and to U.S. Provisional Patent Application No. 63/407,418, which was filed Sep. 16, 2022.

### FIELD

Various embodiments generally may relate to the field of wireless communications. For example, some embodiments may relate to sidelink (SL) systems operating in the unlicensed band. Particularly, embodiments may related to the physical SL control channel (PSCCH) and/or the physical sidelink shared channel (PSSCH) for such a system.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of SL operation in the new radio-unlicensed (NR-U) spectrum, in accordance with various embodiments.

FIG. 2 illustrates an example of PSCCH time allocation, in accordance with various embodiments.

FIG. 3 illustrates an example of PSCCH resource signaling, in accordance with various embodiments.

FIG. 4 illustrates an alternative example of PSCCH resource signaling, in accordance with various embodiments.

FIG. 5 illustrates an example of new radio (NR) SL allocation in time on licensed and unlicensed carriers, in accordance with various embodiments.

FIG. 6 illustrates example physical SL shared channel (PSSCH) and PSCCH allocations, in accordance with various embodiments.

FIG. 7 illustrates an example wireless network in accordance with various embodiments.

FIG. 8 illustrates example components of a wireless network in accordance with various embodiments.

FIG. 9 is a block diagram illustrating example components, according to some example embodiments, able to read instructions from a machine-readable or computer-readable medium (e.g., a non-transitory machine-readable storage medium) and perform any one or more of the methodologies discussed herein.

FIG. 10 illustrates an example network in accordance with various embodiments.

FIG. 11 depicts an example procedure for practicing the various embodiments discussed herein.

FIG. 12 depicts an alternative example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Mobile communication has evolved significantly from early voice systems to today's highly sophisticated integrated communication platform. The next generation wireless communication system, which may be referred to as fifth generation (5G) and/or new radio (NR), may provide access to information and sharing of data anywhere, anytime by various users and applications. NR may be viewed as a unified network/system that may meet vastly different and sometime conflicting performance dimensions and services. Such diverse multi-dimensional requirements may be driven by factors such as different services and applications.

For instance, in the third generation partnership project (3GPP) release-16 (which may be referred to as Rel.16, Rel 16, Rel-16, etc.) specifications, SL communication was developed at least in part to support advanced vehicle-to-anything (V2X) applications. In the 3GPP Release-17 (which may be referred to herein as Rel.17, Rel 17, Rel-17, etc.) specifications, 3GPP studied and standardized proximity-based service including public safety and commercial related services. Further, as part of Rel.17, power saving solutions (e.g., partial sensing, discontinuous reception (DRX), etc.) and inter-UE coordination have been developed at least in part to improve power consumption for battery limited terminals and reliability of SL transmissions. Although NR SL may have initially been developed for V2X applications, there is growing interest in the industry to expand the applicability of NR SL to commercial use cases, such as sensor information (video) sharing between vehicles with high degree of driving automation. For commercial SL applications, two example requirements may be as follows:
Increased SL data rate
Support of new carrier frequencies for SL

To achieve these requirements, one objective of the 3GPP Release-18 (which may be referred to herein as Rel.18, Rel-18, Rel 18, etc.) specifications is to extend SL operation in the unlicensed spectrum, which may be referred to as NR-U SL in the remaining of this disclosure. However allow fair usage of the spectrum and fair coexistence among different technologies, different regional regulatory requirements are imposed worldwide. Thus, to enable a solution for all regions, complying with the strictest regulation from the European Telecommunications Standards Institute (ETSI) Broadband Radio Access Network (BRAN) committee as published, for example, in European Standard (EN) 301 893 may be sufficient. In fact, for the development of NR-U during Rel.16, a 3GPP NR based system complying with these regulations was developed.

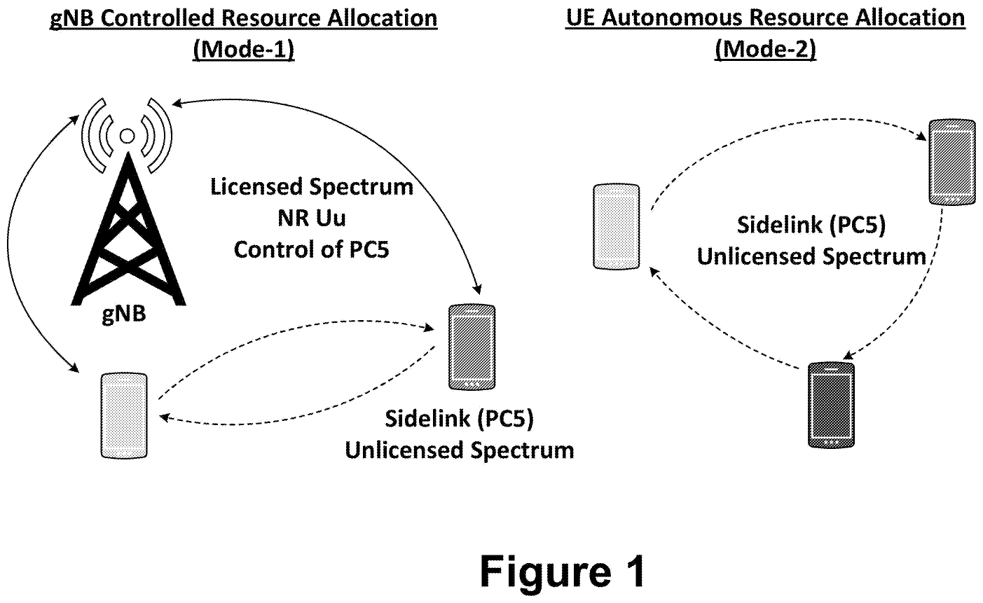

However, given that one target may be to enable a SL communication system in the unlicensed band, the considerations of SL communication systems may need to be combined with the regulator requirements necessary for the operation in the unlicensed bands. For example, NR SL may be operated through two modes of operation: 1) mode-1, where a base station such as a gNodeB (gNB) schedules the SL transmission resource(s) to be used by the UE, and Uu operation is limited to licensed spectrum only; and/or 2) mode-2, where a user equipment (UE) determines (i.e, gNB does not schedule) the SL transmission resource(s) within SL resources which are configured by the gNB/network or pre-configured. FIG. 1 illustrates examples of the two modes of operation.

### PSCCH-Related Issues

In this context, there may be specific challenges to enable NR-U SL. In particular, one of the challenges may be that, when operating in the frequency range-1 (FR-1, e.g. frequencies at or below approximately 6 gigahertz (GHz) or, in some embodiments, frequencies at or below approximately 7 GHz) unlicensed band, a listen before talk (LBT) procedure may need to be performed to acquire the medium before a transmission can occur. The LBT procedure may potentially be performed at any time to significantly improve the overall system performance, and may also result in a SL transmission starting soon after the LBT procedure, so that channel can be grabbed immediately. Another feature when operating in unlicensed spectrum is that the acquired channel by a device may be shared with other devices (e.g., between the UE and the gNB) to allow a more efficient use of a channel occupancy time (COT). Furthermore, ETSI BRAN mandates at any time at least 80% of a nominal channel bandwidth should be occupied as specified through the following text:

4.2.2 Nominal Channel Bandwidth and Occupied Channel Bandwidth
4.2.1 Definition
The Nominal Channel Bandwidth is the widest band of frequencies, inclusive of
guard bands, assigned to a single channel.
The Occupied Channel Bandwidth is the bandwidth containing 99% of the power of
the signal.
When equipment has simultaneous transmission in adjacent channels, these
transmissions may be considered as one signal with an actual Nominal Channel
Bandwidth of “n” times the individual Nominal Channel Bandwidth where “n” is the
number of adjacent channels. When equipment has simultaneous transmissions in
non-adjacent channels, each power envelope shall be considered separately.
4.2.2.2 Limits
The Nominal Channel Bandwidth for a single Operating Channel shall be 20 MHz.
Alternatively, equipment may implement a lower Nominal Channel Bandwidth with
a minimum of 5 MHz, providing they still comply with the Nominal Centre
Frequencies defined in clause 4.2.1 (20 MHz raster).
The Occupied Channel Bandwidth shall be between 80% and 100% of the Nominal
Channel Bandwidth. In case of smart antenna systems (devices with multiple
transmit chains) each of the transmit chains shall meet this requirement. The
Occupied Channel Bandwidth might change with time/payload.
During a Channel Occupancy Time (COT), equipment may operate temporarily with
an Occupied Channel Bandwidth of less than 80% of its Nominal Channel
Bandwidth with a minimum of 2 MHz.

To fulfil these requirements, NR-U, licensed assisted access (LAA) and MulteFire may use an interleaved physical resource block (PRB) mapping, called interlaced mapping.

Furthermore, ETSI BRAN defines a specific class of signals, called short control signaling, which may be transmitted without any LBT or under specific LBT exceptions. A short control signal is a signal which is not transmitted more than 50 times within any observation windows of 50 milliseconds (ms), and within any observation windows its aggregated transmission may not exceed 2.5 ms, as described by the following text:

```
4.2.7.3.3 Short Control Signalling Transmissions (FBE and LBE)
4.2.7.3.3.1 General
Frame Based Equipment and Load Based Equipment are allowed to have Short
Control Signalling Transmissions on the Operating Channel providing these
transmissions comply with the requirements in clause 4.2.7.3.3. It is not required for
adaptive equipment to implement Short Control Signalling Transmissions.
4.2.7.3.3.2 Definition
Short Control Signalling Transmissions are transmissions used by the equipment to
send management and control frames without sensing the channel for the presence of
other signals.
4.2.7.3.3.2 Limits
The use of Short Control Signalling Transmissions in constrained as follows:
  ● within an observation period of 50 ms, the number of Short Control Signalling
    Transmissions by the equipment shall be equal to or less than 50; and
    ● the total duration of the equipment's Short Control Signalling Transmissions
      shall be less than 2500 μs within said observation period.
```

In this sense, in NR-U, the Discovery Reference Signal may be considered to be a short control signaling as a gNB is allowed to transmit it by using type 2A channel access to acquire the channel, instead of using type 1 LBT.

On the other hand, the NR SL may be targeted for operation in licensed spectrum, and the starting time of the PSCCH may only be at the start of a SL slot. In addition, the functionality of the control channel for the NR SL may be split into two stages. The first stage has the main target of providing sensing information for independent resource selection. Whereas the second stage provides all necessary information for shared channel demodulation.

Embodiments herein are provided to enhance SL to operate in unlicensed spectrum. In particular, embodiments relate to harmonizing the SL physical control channel with the NR-U design so that the aforementioned regulatory restriction(s) may be met in SL when operating in the unlicensed spectrum in FR-1.

### Frequency Allocation

In contrast to the NR SL, in NR-U SL one or more OCB (which may refer to “occupied channel bandwidth”) requirements may need to be considered and met. One or more of the following example design options (and/or some other design option) may be considered for PSCCH allocation of frequency resources:
In one embodiment sub-channel-based allocation of NR SL is reused with the resource blocks (RBs) of a sub-channel being mapped to physical resources in an interleaved fashion. This means that the frequency resources of each sub-channel are distributed throughout all frequency resources. In one option of this embodiment, PSCCH is allocated starting from the lowest PRBs of an RB-based interlace, which corresponds to the lowest sub-channel of the sub-channel(s) of the corresponding PSSCH, and may occupy 2 or 3 consecutive symbols.
In one embodiment wideband allocation of all available frequency resources of the control channel is introduced, which are mapped over a minimum bandwidth of 20 megahertz (MHz), or in multiple of 20 MHz.

For sub-channel-based frequency allocation there are different options for the position of the PSCCH (first or single stage) within the sub-channels. In this sense, the following embodiments are provided:
In one embodiment, as in Rel.16 SL the PSCCH is only contained within one of the sub-channels. This can be the lowest or highest index of all allocated sub-channels. In this case the PSCCH can always occupy all frequency resources in one sub-channel. It is however also possible that as in NR SL Rel. 16 a subset of all frequency resource within a sub-channel are configured for the transmission of the PSCCH.
In one embodiment, for all orthogonal frequency division multiplexed (OFDM) symbols carrying PSCCH all available frequency resources of all allocated sub-channels are allocated to the PSCCH. Note that relative to Rel. 16 this means that now for each potential decoding size a decoding attempt may be necessary. These decoding attempts may be reduced by a preceding stage of PSCCH demodulation reference signal (DMRS) presence detection.

### Time Allocation

The time allocation may relate to one or more of the following example design principles (and/or some other design principle in other embodiments):
PSCCH preparation time
Fast PSCCH processing time
Number of resources used for PSCCH should achieve desired coverage

Combining all these design principles may lead to the requirement that the PSCCH should occupied the L earliest resources available for the transmission. Furthermore, different signaling requirements may lead to different number of resources required to achieve a certain coverage. For Rel. 16 NR SL, L was configurable to a value of 2 or 3. However, given that the SL control information (SCI) payload may need to be modified and may be increased as highlighted later in this disclosure, in one embodiment, for NR-U SL the value of L could be additionally increased to X symbols, where X could be as an example 4, 5, 6, or some other higher value.

### Transmission Start

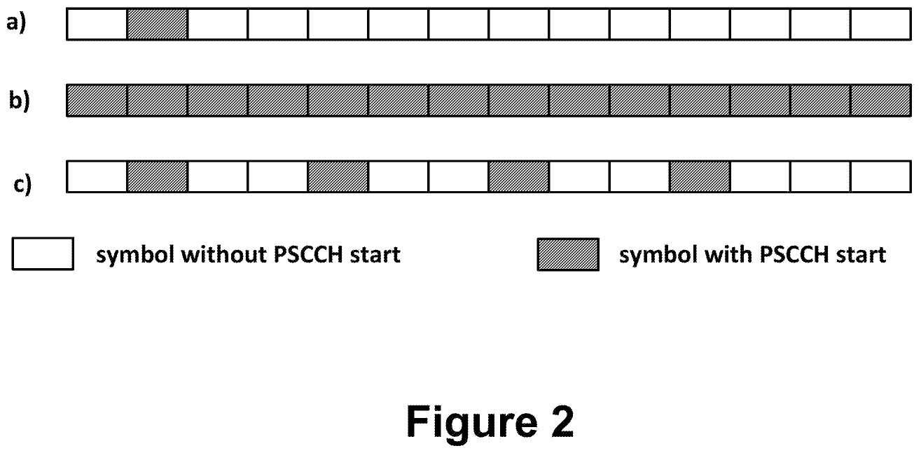

As mentioned above, in an unlicensed system it may be highly beneficial to allow a device to potentially perform LBT at any time within a slot. If this design principle is also applied to NR-U SL, it may be beneficial for a SL transmission to also be allowed to also start at any time. This can be accomplished by enabling the start of the PSSCH within each symbol of each slot. However, in contrast to the downlink (DL), it may be desirable in the uplink (UL) that the PSSCH is in all cases accompanied by a PSCCH, and before decoding the PSCCH (required time is T_{proc,0}^{SL}) all PSSCH information may need to be buffered. With that said, the following example embodiments are provided with respect to FIG. 2:
In one embodiment, the PSCCH only starts at the beginning of the slot.
In one embodiment, the start of the PSCCH occurs in a specific symbol within a slot, for example in symbol #1 (e.g., the dark grey symbol as illustrated in FIG. 2a). In this case up to 13 OFDM symbols of PSSCH need to be kept inside the buffer.
In one embodiment, the start of the PSCCH occurs in each OFDM symbol (as illustrated in the dark grey symbols of FIG. 2b). In this case no buffering of the PSSCH before the PSCCH reception is necessary.
In one embodiment, the start of the PSCCH occurs in (pre)-configured OFDM symbols (e.g., the dark grey symbols as illustrated in FIG. 2c).

In one embodiment, the start may also dependent on the automatic gain control (AGC) adaptation. If the transmission of the PSCCH is not combined with other transmissions in the same OFDM symbol and not perfectly adapted, AGC might not harm the PSCCH performance. It is also possible to reduce the number of blind PSCCH decodings by presence detection of the PSCCH DMRS.

In one embodiment, in case a transmission may prolong over multiple slots one or more of the following may be true:
In another option, the PSCCH is only carried in the first slot following one of the embodiments provide above;
In another option, the PSCCH is carried in every slot according with one of the embodiments provide above.

### Single Stage or Standalone SCI Design

It is possible that NR-U SL may require a standalone control channel. A standalone control channel would utilize one of the time frequency allocation methods described above and may additionally be used to carry HARQ feedback information.

In this case, in one embodiment the control channel (e.g., the PSCCH) for SL operating in an unlicensed band is implemented as a two-stage design. In this case both stages have separate coding, and cyclic redundancy check CRC. The transmission of the first stage is based on PSCCH DMRS. Whereas the second stage is based on shared channel (PSSCH) DMRS.

In another embodiment, the control channel (PSCCH) for SL operating in an unlicensed band consists of a single stage that uses polar coding and PSCCH DMRS. As an option of this embodiment, a standalone PSCCH might be transmitted and qualified as a short control signal allowing a UE to either transmit it without any listen-before-talk (LBT) or using type 2A LBT if the UE may need to acquire a new channel occupancy time (COT) to transmit the PSCCH, and PSCCH can be qualified as short control signaling based on the requirements mentioned above.

### PSCCH Signaling Fields

In one embodiment, a control channel (PSCCH) for SL operating in an unlicensed band that is used to signal the necessary information for demodulation of the shared channel may contain at least one or more of the following example fields (and/or some other field in other embodiments):
Modulation coding scheme (MCS)
PSSCH resources
Number of spatial layers
DMRS time location and used port
Presence of channel state information (CSI)
Presence of SL positioning reference signal (PRS)
Hybrid automatic repeat request (HARQ) related information such as a HARQ identifier (ID) and/or HARQ feedback enabled/disabled indicator
Source and destination ID
Information for sensing
Periodicity and/or offset for semi-static channel access mode
Channel access priority class
Additional reserved resources to allow transmission soon after the LBT procedure (e.g. cyclic prefix (CP) extension)
COT sharing related information such as whether the COT is shared, and how long the remaining COT may be.
Remaining COT
Indication on whether the current device operates as initiating or responding device
HARQ feedback (may only be needed for standalone)
Additional reserved resources or resources for additional transport blocks (TBs)
HARQ information for the transmission of additional TBs

Note that the SCI information listed above can be signaled within the PSCCH, as first stage or second stage SCI, as standalone SCI piggyback in PSSCH or even in higher layer signaling such as a medium access control (MAC)-control element (CE).

### PSCCH Preparation

In contrast to Rel.16 NR SL, in SL operating in unlicensed spectrum it may be possible that a transmission may potentially start at any time depending on when LBT may start. In this sense, a UE may not be able to predict when a transmission may start, and all related transmission symbols need to be prepared in advance before the actual transmission taking in account that LBT may possibly fail. This means that all related PSCCH DMRS and coded bits need to be prepared. As the SCI information bit can be dependent on the start of transmission either this dependency needs to be eliminated or all options need to be pre-prepared. Now the PSCCH DMRS is dependent on the OFDM symbol number within a slot. As for the case of NR-U SL this might not always be known well in advance of the transmission. For this reason, in order to solve this issue, one or more of the following example embodiments may be used.

In one embodiment, the PSCCH DMRS symbols depend on the number of OFDM symbols relative to the start of the PSSCH transmission.

In another embodiment, the PSCCH DMRS sequence in each OFDM symbol with PSCCH DMRS is only dependent on being the xth OFDM symbol with PSCCH DMRS within the current slot.

### PSCCH Resource Signaling for Multi-Slot Transmissions

To allow a better spectrum utilization of a COT initialized by a UE, it may be highly beneficial to allow such UE to perform transmissions which may span over multiple slots, rather than a single SL slot as in Rel 16 SL.

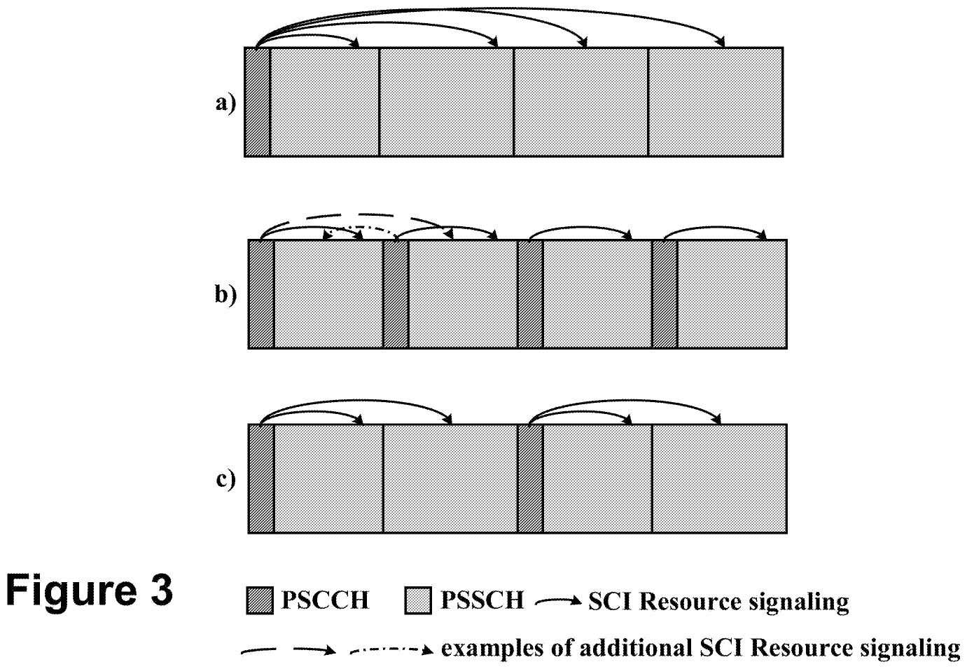

In this matter, one or more of the following example options (and/or some other option) as described with respect to FIG. 3 may be used:
Option 1a: In one embodiment, one SCI information is used to signal all resources in all slots used for transmission, as illustrated, for example, in FIG. 3a.
   In one option, the SCI indicates the consecutive number of slots that a UE may use for transmission.
   In one option, in the SCI there are parameters that needs to be applied only once over consecutively scheduled slots and, thus, no need to be signalled multiple times. This includes for example, SL priority, frequency resource assignment, DMRS pattern and MCS.
   In one option, in the SCI there are also parameters that can be signalled only for the first slot and the parameters for the following slots are derived according to some pre-defined rule. For instance the HARQ process ID for the first slot is signalled and the HARQ process ID for the following slots can be chosen in a successive manner.
   In one option, some information needs to be separately signalled for multiple slots such as NDI, RV, and destination ID.
Option 1b: In one embodiment, when two stage SCI is used, one first stage SCI information is used to signal all resources in all slots used for transmission, while second^{d} stage SCI is provided in each individual slot.
Option 2: In another embodiment, multiple SCI are used to signal the resources in a subset of slots, as illustrated, for example, in FIG. 3b or 3c. In one example, either one stage or two stage SCI is used, and PSCCH is carried within each SL slot of a multi-slot burst transmission (e.g., as illustrated in FIG. 3b).

In one embodiment, for SL mode 1 in unlicensed spectrum, either DCI 3_0 or 3_1 may be enhanced so that to allow multi-slot scheduling. In this sense,
In one option, in the DCI 3_x there are parameters that needs to be applied only once over consecutively scheduled slots and, thus, no need to be signalled multiple times. This includes for example, frequency resource assignment, and resource pool index.
In one option, in the DCI 3_x there are also parameters that can be signalled only for the first slot and the parameters for the following slots are derived according to some pre-defined rule. For instance, the HARQ process ID for the first slot is signalled and the HARQ process ID for the following slots can be chosen in a successive manner.
In one option, some information within the DCI 3_x needs to be separately signalled for multiple slots such as a new data indicator (NDI).
In one option, COT sharing parameters related to UEs doing multi-slot transmissions need to be signalled. As the gNB does not necessarily know how many TBs a UE has to transmit it is possible to still allow for COT sharing. In this case the network would signal a device to transmit in a COT sharing fashion after the transmission of one other has concluded. In this way COT sharing can be configured without prior knowledge of the number of TBs one UE does have to transmit.

In one embodiment, a resource pool may be always configured following one or more of the following constrains:
The resource pool is not configured with a size smaller than the LBT bandwidth (BW);
The sub-channel size cannot exceed 20 MHz.

In order to indicate the time domain resources within a resource pool, in one embodiment, a bitmap indication is used as Rel.16 to indicate the time division duplexed (TDD) configuration. In one option, the bitmap configuration is always configured with all ‘1’ so that to avoid unnecessary gaps across SL transmission and so that all slots could be potentially used for SL transmission.

In one embodiment, sl-TxPoolScheduling is enhanced so that to include an additional dedicated parameter which signals the number of slots over which a specific element of the resource pool may span. Notice that as an alternative, unused fields within the SL-ResourcePool information element (IE) could be reinterpreted and used to indicate the number of slots allocated for an element of the resource pool.

Given that resource within a resource pool may not always be orthogonal and given that a gNB may not be aware of the buffer occupancy of a UE, a gNB may overprovision multiple slots which may not be used by a UE and may in fact prevent another UE from using. In this sense, some indication from a UE on how many slots it may use is beneficial. In this sense, in one embodiment, a UE may include within SCI (either stage 1 or stage 2 or both) or single-stage SCI a field indicating the number of slots over which a SL transmission may occur.

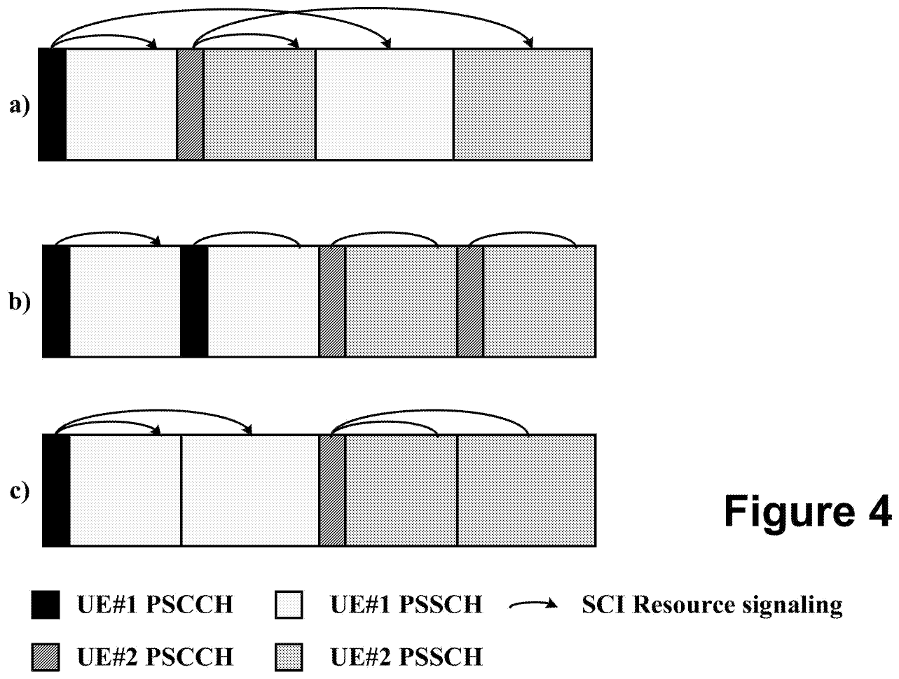

In one embodiment, a multi-slots continuous transmission may be employed via multiple UEs, which may perform back-to-back SL transmissions so that to form a contiguous SL burst. Similarly, to the case when the multi-slots continuous transmission is employed by a single UE, one or more of the following examples, as described with respect to FIG. 4, may be used:
Option A: In one embodiment, one SCI information per UE is used to signal all resources in all slots used for transmission by a UE, and resources across UEs are scheduled or (pre-)configured so that cumulatively they form a contiguous burst, for example as illustrated in FIG. 4a).
Option B: In one embodiment, two stage SCI is used per UE, one 1^{st} stage SCI information is used to signal all resources in all slots used for transmission by a UE, while 2^{nd} stage SCI is provided in each individual slot, and resources across UEs are scheduled or (pre-)configured so that cumulatively they form a contiguous burst.
Option C: In another embodiment, multiple SCI are used by a UE to signal the resources in a subset of slots, for example as illustrated in FIG. 4b or FIG. 4c, and resources across UEs are scheduled or (pre-)configured so that cumulatively they form a contiguous burst.

Regardless of whether Option A, B or C is adopted, within a multi-slots contiguous transmission employed by multiple UEs, a participating UE, before transmitting, may always be expected to fulfil one or more of the following:
Detect whether a transmission from another UE has occurred/has been occurring or not, and only in case it may be able to verify that a prior transmission from another UE has occurred/has been occurring and the gap between the end of this prior transmission and its transmission is smaller than 16 us it can perform the transmission without performing LBT.
The transmission that the UE is supposed to perform falls entirely within its own COT, if that UE is the initiating of the multi-slots contiguous transmission, or within the COT of the UE that has initially initiated the multi-slots contiguous transmission, and no transmission can prolong past the maximum COT (MCOT).

In one embodiment, for SL resource allocation (RA) mode 1 in unlicensed spectrum, a new DCI format may be introduced to the 3GPP specifications at least in part to allow multi-slot scheduling for multiple UEs. In this sense, one or more of the following example options (and/or some other option) may be as follows:
In one option, in the new DCI, there are parameters that need to be applied only once for all UEs over consecutively scheduled slots and, thus, no need to be signalled multiple times. This includes for example, frequency resource assignment.
In one option, in the new DCI, there may also be parameters that can be signalled only for the first slot of each UE and the parameters for the following slots are derived according to some pre-defined rule. For instance, the HARQ process ID for the first slot may be signalled and the HARQ process ID for the following slots can be chosen in a successive manner.
In one option, some information within the new DCI may need to be separately signalled for multiple slots and for each UE such as NDI.

### SL Power Control

In Rel.16, the power control in SL is only based on open loop, and it is channel specific. In fact,

$${P}_{SSCH} ( i ) = min ( {P}_{CMAX} , {P}_{MAX , CBR} , min ( {P}_{PSSCH , D} ) ( i ) , {P}_{PSSCH , SL} ( i ) ) ) [ dBm ]$$

$${P}_{PSCCH} ( i ) = 10 {log}_{10} ( \frac{{M}_{RB}^{PSCCH} ( i )}{{M}_{RB}^{PSSCH} ( i )} ) + {P}_{PSSCH} ( i ) [ dBm ]$$

where P_{CMAX} is the maximum output power based on the UE power class, P_{MAX,CBR} is the maximum effective isotropic radiated power (EIRP) imposed according to requirements and channel busy ratio determined during the congestion control mechanism (if configured), P_{PSSCH,D}(i) is the power allocation accounting for the DL pathloss, P_{PSSCH,SL}(i) is the power allocation accounting for the SL pathloss, M_{RB}^{PSCCH}(i) is a number of resource blocks for the PSCCH transmission in PSCCH-PSSCH transmission occasion i, and M_{RB}^{PSSCH}(i) is a number of resource blocks for PSCCH-PSSCH transmission occasion i. Furthermore, for PSSCH/PSCCH a UE can be configure to use one or more of the following alternatives when deriving the transmit power to use:
Alt.1—Utilize the DL pathloss only (available only in mode 1)
Alt.2—Utilize the SL pathloss only
Alt.3—Utilize both the DL (available only for mode 1) and SL pathloss.

Additionally, for the physical SL feedback channel (PSFCH), open loop power control is also used, and the power allocation for PSFCH in slot i is calculated as follows:

$${P}_{PSFCH , one} = {P}_{O , PSFCH} + 10 {log}_{10} ( {2}^{μ} ) + {α}_{PSFCH} \cdot PL [ dBm ]$$

$${P}_{PSFCH , k} ( i ) = min ( {P}_{CMAX} - 10 {log}_{10} ( {N}_{Tx , PSFCH} ) , {P}_{PSFCH , one} )$$

where N_{Tx,PSFCH} is the number of actually transmitted PSFCH, N_{sch,Tx,PSFCH} is the number of pending PSFCH transmissions, N_{max,PSFCH} is the maximum number of PSFCH transmissions per capability, P_{O,PSFCH}, α_{PSFCH} is provided by higher layers, and PL is the downlink pathloss.

Moving forward to NR-U SL, when OCB requirements must be met and the PSCCH may span over the entire BW or over the entire resource elements (Res) within a specific symbol (e.g. first symbol) of a SL slot. In this case, the transmit power for PSCCH can no longer be calculate as in legacy design and expressed through the equation above.

In one embodiment, in case a system must be obliged to meet the ETSI BRAN OCB requirements, the power control for PSCCH may be calculated as follows based on a specific higher layer signaling which may indicate that this type of constraint must be met:

P_{PSCCH}(i)=P_{PSSCH}(i)[in decibel-milliwatts(dBm)]

In another embodiment, P_{PSCCH}(t) P_{PSSCH}(i) [dBm] is utilized when ETSI BRAN OCB requirement must be met and related higher layer signalling indicates so, irrespective of whether a UE operates within or outside a COT.

In another embodiment, when ETSI BRAN OCB requirement must be met and related higher layer signalling indicates so, an initiating device derives the power allocation for PSCCH transmission as P_{PSSCH}(i)=min(P_{CMAX}, P_{MAX,CBR}, min(P_{PSSCH,D}(i), P_{PSSCH,SL}(i))) [dBm], while for a responding device P_{PSCCH}(i)=P_{PSSCH}(i) [dBm].

In another embodiment, when higher layers configure the use of PSCCH power boosting, and the PSCCH bandwidth is smaller than the associated PSSCH, the PSCCH as well as all REs that belong to the associated PSSCH in the OFDM symbols after that have a higher power. In this case the power of the PSSCH (and the power boosted PSSCH REs) is calculated as

$${P}_{PSCCH} ( i ) = 10 {log}_{10} ( \frac{{M}_{RB}^{PSCCH} ( i )}{{M}_{RB}^{PSSCH} ( i )} ) + {P}_{PSSCH} ( i ) + {P}_{boost} [ dBm ] ,$$

where P_{boost} is a power boosting factor expressed in dB.

Notice that the embodiments listed here are not mutually exclusive, and one or more of them may apply together.

For NR-U SL, the PSFCH physical design may be enhanced to span over a larger BW (>1 PRB), and the power allocation may no longer be calculated by using the equation provided above. Note that for the power control, the number of PSFCH RBs are the combined RBs of all PSFCH occasions that are transmitted in the same OFDM symbols.

In one embodiment, one or more of the following could be adopted:

$${P}_{PSFCH , k} ( i ) = {P}_{PSSCH} ( i ) [ dBm ]$$

$${P}_{PSFCH , one} = {P}_{O , PSFCH} + 10 {log}_{10} ( {2}^{μ} \cdot {M}_{RB}^{PSFCH} ( i ) ) [ dBm ]$$

$${P}_{PSFCH , k} ( i ) = min ( {P}_{CMAX} - 10 {log}_{10} ( {N}_{Tx , PSFCH} ) , {P}_{PSFCH , one} )$$

where M_{RB}^{PSFCH}(i) is number of resource blocks for a PSFCH transmission, and PL_{D} is the DL pathloss.

$${P}_{PSFCH , one} = {P}_{O , PSFCH} + 10 {log}_{10} ( {2}^{μ} \cdot {M}_{RB}^{PSFCH} ( i ) ) + min ( {α}_{PSFCH} \cdot {PL}_{D} , {α}_{PSFCH} \cdot {PL}_{SL} ) [ dBm ]$$

$${P}_{PSFCH , k} ( i ) = min ( {P}_{CMAX} - 10 {log}_{10} ( {N}_{Tx , PSFCH} ) , {P}_{PSFCH , one} )$$

where M_{RB}^{PSFCH}(i) is number of resource blocks for a PSFCH transmission, PL_{D} is the DL pathloss, and PL_{SL} is the SL pathloss.

For this option, a UE may be configured to use on of the following alternatives:
Alt.1—Utilize the DL pathloss only (i.e, PL_{SL}=0)
Alt.2—Utilize the SL pathloss only (i.e, PL_{D}=0)
Alt.3—Utilize both the DL and SL pathloss.

### Multi-Carrier Operation

When a SL system operates on a multiple of 20 MHz BW, in one embodiment one or more of the following example options (and/or some other option) could be adopted:
When operating in dynamic channel access mode, both type A and type B DL multi-carrier procedure as defined in Rel.16 NR-U are supported, meaning that transmission is allowed in any LBT BW for which the related LBT succeeds.
When operating in dynamic channel access mode, both type A and type B UL multi-carrier procedure as defined as defined in Rel.16 NR-U are supported, meaning that transmission is allowed only as long as LBT succeeds in every LBT BW.
When operating in dynamic channel access mode, both the Rel.16 NR-U DL multi-carrier procedure and the Rel.16 NR-U UL multi-carrier procedure is supported.
   In one option, the Rel.16 NR-U DL multi-carrier procedure is applied for UEs in RA mode 2, while the UL multi-carrier procedure is applied for UEs in RA mode 1, or vice versa.
   In one option, whether the Rel.16 NR-U DL or Rel.16 NR-U UL multi-carrier procedure would be used, it is up to UE's capability or a UE specific or cell specific (pre-)configuration.

It will be noted that two or more of the previously-provided options/embodiments may not be considered to be mutually exclusive, and may be jointly adopted.

### PSSCH-Related Issues

As previously noted, there may be several specific challenges to enable NR-U SL. In particular, one of the challenges is that, when operating in the FR-1 unlicensed band a LBT procedure may need to be performed to acquire the medium before a transmission can occur. While operating in an unlicensed spectrum, a SL system may co-exist and compete with other incumbent technologies for frequency resources. In this matter, while in SL a transmission may start always at a same configured starting position, other technologies may have the flexibility to initiate a transmission at any time giving them an inherent advantage and higher likelihood to succeed with the LBT procedure and acquire a COT. Embodiments of the present disclosure address these and other issues.

Furthermore, in some SL implementations, only single slot transmissions may occur at a given time. However, this may be disadvantageous when operating in unlicensed spectrum because, even when a COT is acquired, if there is a gap larger than 16 microseconds (us) between two SL bursts, an LBT procedure is mandated (e.g., in dynamic channel access mode either type 2A or 2B depending on the exact size of the gap) to be able to resume transmission. In this case, if short transmissions separated in time are performed within a COT, this may lead a high LBT overhead and to a poor spectrum utilization since the gaps may allow other device from incumbent technologies to acquire the channel and monopolizing it efficiently for an entire MCOT, leaving in many cases a SL UE unable to resume a transmission, and utilizing inefficiently the spectrum. To mitigate this problem, embodiments of the present disclosure are directed to multi-slot SL transmission, and several design options are provided.

Some embodiments of this disclosure are directed to enhancements for SL physical shared channel (PSSCH) to allow a transmission to more flexibly occur and allow a more efficient use of the spectrum through a multi-slot/multi-TP transmission.

### Start and End Time of a PSSCH Transmission

As indicated above, when operating a SL system in unlicensed spectrum, it may be important to note that the LBT procedure will need to be mandatorily performed. Depending on deployment, a SL system will need to compete with incumbent technology (or technologies) for accessing and utilizing the spectrum for transmissions. In this matter, while in licensed spectrum a SL system is designed so that all transmissions occur at a configured starting time to allow a UE to properly handle AGC to mitigate analog-to-digital convertor (ADC) quantization errors and clipping noise, in unlicensed spectrum this may be detrimental from a spectrum utilization point of view, since within a slot a UE may only have a single opportunity to perform LBT. With that said, when an incumbent technology is present, it may be beneficial to also allow SL transmissions to start at any point in time and perform LBT in multiple instances of time. While LBT may not always be performed at an ODFM symbol boundary, in this case CP extension or any other techniques could be used to fill the gap between the end of LBT and the start of the PSSCH transmission. In this matter, PSSCH could potentially start at any ODFM symbol. However, note that the assumption here is that the adaptation of the AGC necessary before the PSSCH transmission is either including one single OFDM symbol or in special cases can reuse the CP extension of another transmission. In another option, it is also possible that if the start of the transmission only includes the PSCCH (control channel) then all AGC adaptation is performed during the control channel reception. Notice that the detailed considerations for these aspects are not handled in this disclosure and it is for the purpose of this disclosure to simply assume that the AGC is either fully adapted before the PSSCH transmissions or can be adapted within a single OFDM symbols.

### Start of a SL Transmission

In one embodiment, for SL communication on unlicensed carriers, a UE may adopt one or more of the following example options on when to start a SL transmission:
Option 1: A UE may start a SL transmission at any arbitrary symbol within a slot, and transmission could span across slot boundaries, when this is possible (e.g. no PSFCH region in between), and multi-slot transmissions is supported. This option applies regardless of whether an incumbent technology may or may not be present.
Option 2: A UE may start a SL transmission at any arbitrary symbol within a slot, and transmission could span across slot boundaries, when this is possible (e.g. no PSFCH region in between), and multi-slot transmissions is supported. This option could be configured by the network when this assesses that an incumbent technology may be present.
Option 3: A UE may start a SL transmission at a pre-configured symbol within a slot and transmit within and/or across slot boundaries, when multi-slot transmissions is supported. This option applies regardless of whether an incumbent technology may or may not be present.
Option 4: A UE may start a SL transmission at a pre-configured symbol within a slot and transmit within and/or across slot boundaries, when multi-slot transmissions is supported. This option could be configured by the network when this assesses that no incumbent technology may be present.
Option 5: A UE may start a SL transmission at a pre-configured set of symbols within a slot and transmit within and/or across slot boundaries, when multi-slot transmissions is supported. This option applies regardless of whether an incumbent technology may or may not be present.
Option 6: A UE may start a SL transmission at a pre-configured set of symbols within a slot and transmit within and/or across slot boundaries when multi-slot transmissions is supported. This option could be configured by the network when this assesses either that no incumbent technology may be present or that the incumbent technology may be present. Note that:
   Some of the options above do not preclude SL transmissions to occur within predefined start/end slot boundaries as in Rel.16/Rel.17.
   A cell-specific or UE-specific higher layer signaling may be needed to be introduced when multiple of the above options may be supported to allow the gNB to indicate a UE or a group of UEs or all the associated UEs which option may need to used at a given time.

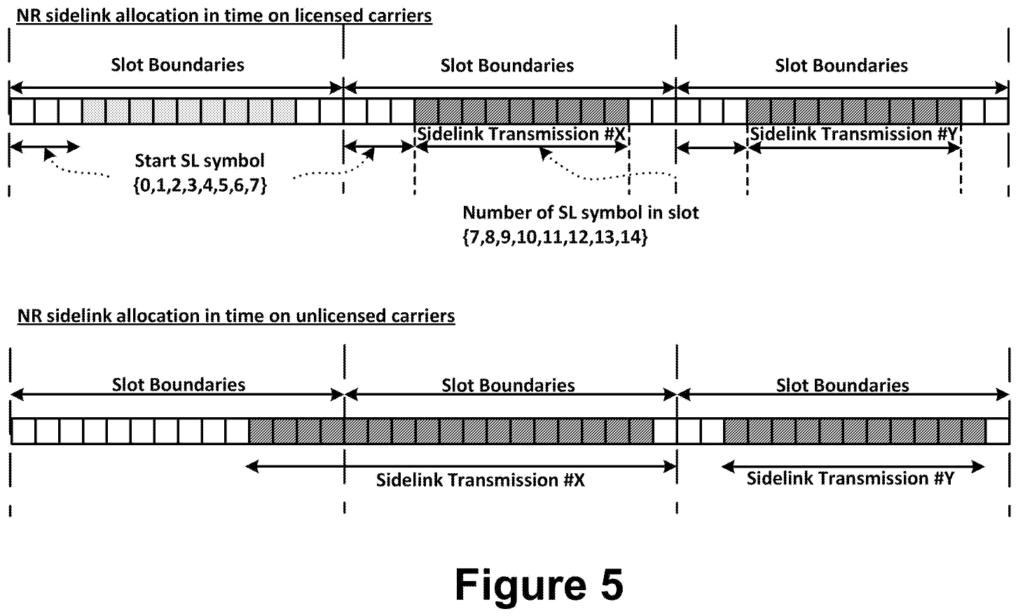

FIG. 5 depicts a comparative example between the NR SL allocation in time on a licensed carriers (within slot boundaries) and that on unlicensed carriers (across slot boundaries).

### End of a SL Transmission

In one embodiment, for SL communication on unlicensed carriers, a UE may adopt one or more of the following example options on when to stop a SL transmission:
Option 1: A UE may stop a SL transmission before the last symbol in a slot or last slot in which it will be continuously transmitting.
Option 2: The second to last symbol is left by a UE to be used for Tx/Rx switching and as an LBT gap to allow other UEs to potentially start a SL transition in the following slot.
Option 3: A UE may stop a SL transmission at an OFDM symbol or time within a slot that is enabling a Tx/Rx switching gap to the start of a PSFCH transmission. Note that this point in time does not necessarily mean the transmission has to end at the end of an OFDM symbol as to fulfil the LBT gap as well as the TX/RX switching time requirements might require a cyclic suffix extension of the PSSCH or a cyclic prefix extension of the PSFCH.
Option 4: A UE may stop a SL transmission at any arbitrary symbol within a slot.
Option 5: a UE may stop a SL transmission at a predefined symbol within a slot. Notice this specific symbol could be either fixed or configurable.
Option 6: Give predefined set of symbols, a UE may stop a SL transmission at any of such symbols within a slot. Notice that the set of symbols could be either fixed or configurable. Note that:
   A cell-specific or UE-specific higher layer signaling may be needed to be introduced when multiple of the above options may be supported to allow the gNB to indicate a UE or a group of UEs or all the associated UEs which option may need to used at a given time.
   As an additional option, in order to enable more efficiently a COT sharing, it is possible to artificially prolong a transmission until the start of the following transmission performed by either the same UE or another UE with which the COT is shared.

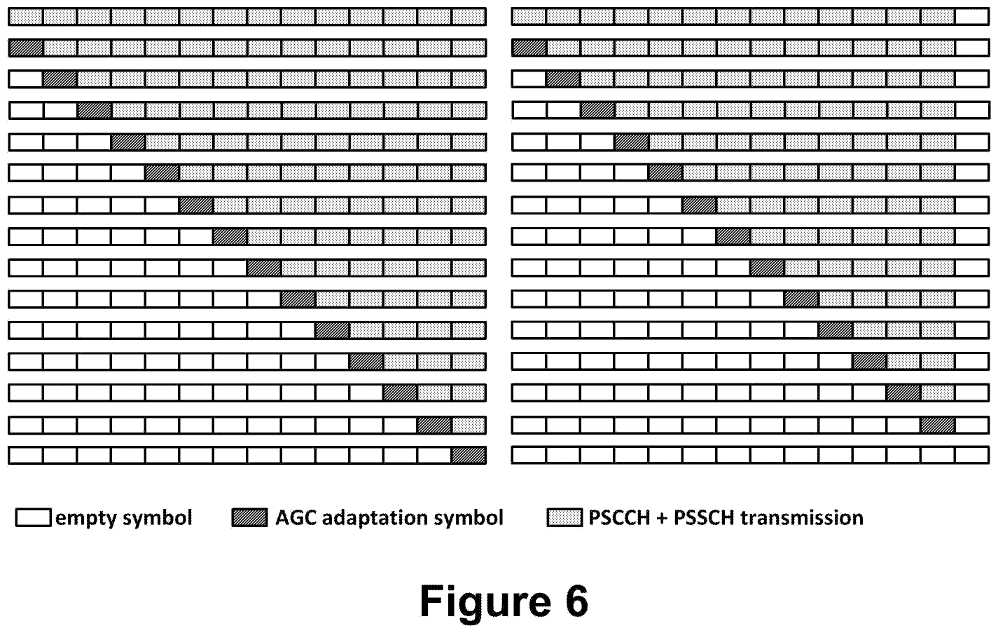

FIG. 6 depicts potential starting positions and resource allocations that, in principle, could be supported. However, it will be understood that, if the same device or devices transmit in consecutive slots, no further adaptation of the AGC is necessary. Thus, for these cases, the transmission can start at the first OFDM symbol in a slot. One example of a case where this can be guaranteed are multi-slot transmissions, where due to continuation of a transmission no AGC is needed.

### Frequency Domain Allocation

In one embodiment, one or more of the following example design options may be considered for PSSCH allocation in frequency domain:
Option 1—Sub-channel-based allocation:
   Option 1a: The sub-channels are as in Rel.16, and they are directly mapped to physical resources.
   Option 1b: the sub-channel are composed by an interlaced mapping of the PRBs belonging to one sub-channel.
Option 2—Wideband allocation:
   Option 2A—Wideband interlaced allocation:
      This is based on a distributed sub-channel mapping. In this case the sub-channel structure for NR SL is reused, but the PRBs of each sub-channel are mapped to PRB in a distributed manner. In this case it is also possible that the currently unused PRBs are also included in this mapping.
   Option 2B—Wideband contiguous allocation:
      This is based on a distributed sub-carrier mapping. In this case all useable sub-carriers are divided into X parts. Each portion is mapped to frequency resource in a comb-x structure with different offsets.

### DMRS Considerations

For Rel.16 NR SL the DMRS pattern is dynamically signaled inside the SL control information (SCI) and the different options are preconfigured per resource pool. However, for NR SL-U, in one embodiment, one or more of the following two example options could be adopted for the PSSCH DMRS:
Option 1: Dynamically signaled PSSCH DMRS time density selected from a set of options preconfigured per resource pool. In this case similar to Rel.16 different density options are configured per resource pool. The transmitter can then dynamically select from these options and signal the used DMRS time density inside the SCI. The main reason for this was the Rel.16 SL was developed with V2X in mind options for DMRS time density to accommodate a fast-changing channel (up to 550 kilometer per hour (km/h) relative speed of transmit/receive (Tx/Rx) leading to higher Doppler spread).
Option 2: Per resource pool configured PSSCH DMRS time density. This means that the PSSCH time density is configured per resource pool and no other time density can be dynamically changed. As for the use case envisioned for NR-U SL no high-speed scenarios are necessary. It is sufficient to have one PSSCH DMRS time density configured per resource pool or configured through the network.

Depending on the chosen design for the PSCCH, PSSCH DMRS time density for a small number of OFDM symbols may need to be designed. For Rel.16 NR SL a maximum of 2 orthogonal spatial layers can be used as type-1 DMRS. Note that the physical structure of the Rel.16 NR SL DMRS can theoretically support up to 4 orthogonal spatial layers. If a higher number of spatial layers is desired either type-2 DMRS or dispreading in time needs to be used. ECP will also be supported by the related configurations with smaller number of OFDM symbols.

In this matter, in one embodiment, one or more of the following options could be employed for PSSCH DMRS types and ports:
Option 1: Same as for Rel. 16 SL only type-1 DMRS with 1 OFDM symbol
Option 2: Type-2 DMRS with on OFDM symbol
Option 3: Type-1 and type-2 DMRS with one OFDM symbol
Option 4: Type-1 DMRS with one or two OFDM symbols
Option 5: Type-2 DMRS with one or two OFDM symbols
Option 6: Type-1 and Type-2 DMRS with one or two OFDM symbols

These can either be (pre)-configured for resource pool configuration or dynamically signaled in the SCI (either stage 1 or stage 2 or both) or DCI 3_x (also depending on if the system operates in mode-1 or mode-2).

Furthermore, in one embodiment, different signaling of the time allocation of the PSSCH DMRS can be considered, and one of the following options could be adopted
Option 1: Signaling and configuration in terms of the number of OFDM symbols with PSSCH DMRS.
Option 2: Signaling and configuration in terms of time density, thus defining the maximum time distance between any PSSCH RE and it's closes PSSCH DMRS RE in terms of OFDM symbols

### 2^{nd} Stage SCI or SCI Piggybacking Considerations

In one embodiment, the 2-stage SCI procedure defined in Rel.16 could be reused. In another embodiment, SCI could be piggybacked within every PSSCH transmission or in case of multi-slot transmission UCI is piggybacked only in the first PSSCH or in predefined/configured PSSCH transmissions/or slots. In another embodiment, regardless of whether a 2-stage SCI procedure or SCI piggybacked is adopted, the content of SCI may be enhanced to contain among other fields/information also HARQ information.

In one embodiment, one or more of the following example options could be adopted for SCI in terms of modulation:
Only quadrature phase shift keying (QPSK) with single layers transmission as in Rel.16 SL is used;
Only a subset of all available modulation formats used for this part of the transmission (subset from pi/2 binary phase shift keying (BPSK), QPSK, 16 quadrature amplitude modulation (QAM), 64 QAM, 256 QAM, 1024 QAM) is used;
The same modulation as the one used for PSSCH is used.

In one embodiment, one or more of the following example options may be adopted to SCI in terms of multiple input/multiple output (MIMO) layers:
Only single layer transmissions are used. If the PSSCH uses multiple layers, special mapping is implemented (same as Rel. 16 SL)
Same number of layers are used between SCI and PSSCH

Regardless of whether 2^{nd} stage SCI or SCI piggyback is used, the number of resource(s) needs to be determined. The requirement often is that the coverage of the 2^{nd} stage SCI or SCI piggyback is better than the shared channel transmitted at the same time. In particular, in one embodiment, the number of 2^{nd} stage SCI or SCI piggyback REs can be calculated based on one or more of the following considerations:
PSSCH spectral efficiency with either (pre)-configure or dynamic signaled offset (beta-offset);
PSSCH coding rate with either (pre)-configure or dynamic signaled offset (beta-offset);
A maximum number of 2^{nd} stage SCI or SCI piggyback REs (potentially defined es either absolute number of REs or percentage of all PSSCH REs).

In one embodiment, one or more of the following example options could be adopted to SCI in terms of where the SCI resources can be located:
Option 1: Before, after or around the first OFDM symbol with PSSCH DMRS that does not also contain PSCCH REs (Same as Rel. 16 SL)
Option 2: Before, after or around the first OFDM symbol with PSSCH DMRS
Option 3: Including the first M REs in time

### TBS Determination

When operating a SL system in unlicensed spectrum, the TBS determination calculation introduced in Rel.16 NR SL needs to adapt to the enhanced physical structure, and the RE determination may need to be adapted based on changes to PSCCH, PSFCH, and PSSCH DMRS. In particular, in one embodiment, the TBS calculation of SL operating in unlicensed could follow/be based on one of the following considerations/aspects:
PSSCH REs: this does potentially include PSSCH REs in multiple slots in the case that the number of PSSCH resource in the slot that contains the start of the transmission mandates the transmission of the following slot with the same TB. It is also possible, in a separate option, that a reference number of PSSCH REs is considered for TBS calculation.
Subtract the number of PSSCH DMRS REs or a preconfigured average value of the PSSCH DMRS REs.
Subtract 2nd stage SCI or SCI piggyback REs
Include an (pre)-configured value defined to accommodate additional potential overhead from, for example, channel state information reference signal (CSI-RS), phase tracking reference signal (PTRS), PRS, etc.

This calculation procedure may be illustrated in the following way split into first a PSSCH RE per PRB calculation followed by a subtraction of the PSSCH resources:

A UE first determines the number of REs allocated for PSSCH within a PRB (N′_{RE}) by N′_{RE}=N_{sc}^{RB}(N_{symb}^{sh}−N_{symb}^{PSFCH})−Nₒₕ^{PRB}−N_{RE}^{DMRS}, where
N_{sc}^{RB}=12 is the number of subcarriers in a physical resource block,
N_{symb}^{sh}=sl-LengthSymbols−2, where sl-LengthSymbols is the number of sidelink symbols within the slot provided by higher layers,
Nₒₕ^{PRB} is the per PRB overhead given by the higher layers
N_{RE}^{DMRS} is either the actual number of PSSCH DMRS REs or an average number of multiple different time densities can be configured.

A UE determines the total number of REs allocated for PSSCH (N_{RE}) by N_{RE}=N′_{RE}. n_{PRB}−N_{RE}^{SCI,1}−N_{RE}^{SCI,2}, where
nPRB is the total number of allocated PRBs for the PSSCH,
N_{RE}^{SCI,1} is the total number of REs occupied by the PSCCH and PSCCH DM-RS.
N_{RE}^{SCI,2} are the number of 2nd stage SCI REs or the number of SCI piggyback resources.

In SL operating in unlicensed spectrum, in contrast to Rel.16 NR SL, there may be TB retransmissions that actually have a different amount of REs than the original TB transmission. Therefore, in this cas,e some mechanism may need to be defined so that the same TB size (TBS) is also used. In this matter, in one embodiment, one of the following example solutions could be adopted:
Option 1: Reintroduce reference MCS. In this case retransmissions with a potentially different number of PSSCH can just signal these MCS values to indicate that the same TBS as in the original transmission is used. These would be as in the Uu link signaled as MCS without associated code-rate.
Option 2: Make TBS calculation dependent on a reference allocation size which is universally understood and potentially independent of the actual allocation of original transmission and retransmission. This means that all parameters like allocation size, the related DMRS overhead, the number of PSCCH REs, the potential 2^{nd} stage SCI resource, the generic overhead parameter are all taken for a reference (time) allocation. Note that in this case the actual number of frequency resource will still be applied.

### Preparation of PSSCH Transmission

In contrast to Rel. 16 NR SL, when SL is operated in unlicensed spectrum it is not predictable when a transmission would start, while all the related transmission symbols need to be prepared in advance before the actual transmission could occur. This means that if the SL transmission may start potentially in multiple symbols within a slot, all the related PSSCH DMRS and coded bits need to be prepared.

For NR SL, the PSSCH DMRS is dependent on the OFDM symbol number within a slot. As for the case of NR SL-U this might not always be known well in advance. In this sense, in one embodiment, this issue could be solved via one of the following options:
Option 1: The PSSCH DMRS depends on the number of OFDM symbols relative to the start of the PSSCH transmission.
Option 2: The PSSCH DMRS sequence in each OFDM symbol with PSSCH DMRS is only dependent on being the x-th OFDM symbol with PSSCH DMRS within the current slot.

As for the data symbols, in one embodiment, one of the following options could be adopted:
Option 1: TBS determined based on reference allocation size. Only the first symbols equal to the number of available REs are transmitted, rest is assumed to get punctured.
Option 2: TBS determined based on full slot transmission assumption. The first (potentially small) transmission slot only contains the first NRE symbols of an additional redundancy version. Other symbols of the first transmission are assumed to be punctured. The following full slot contains all symbols of the same TB using a different redundancy version than the first transmission.

### Systems and Implementations

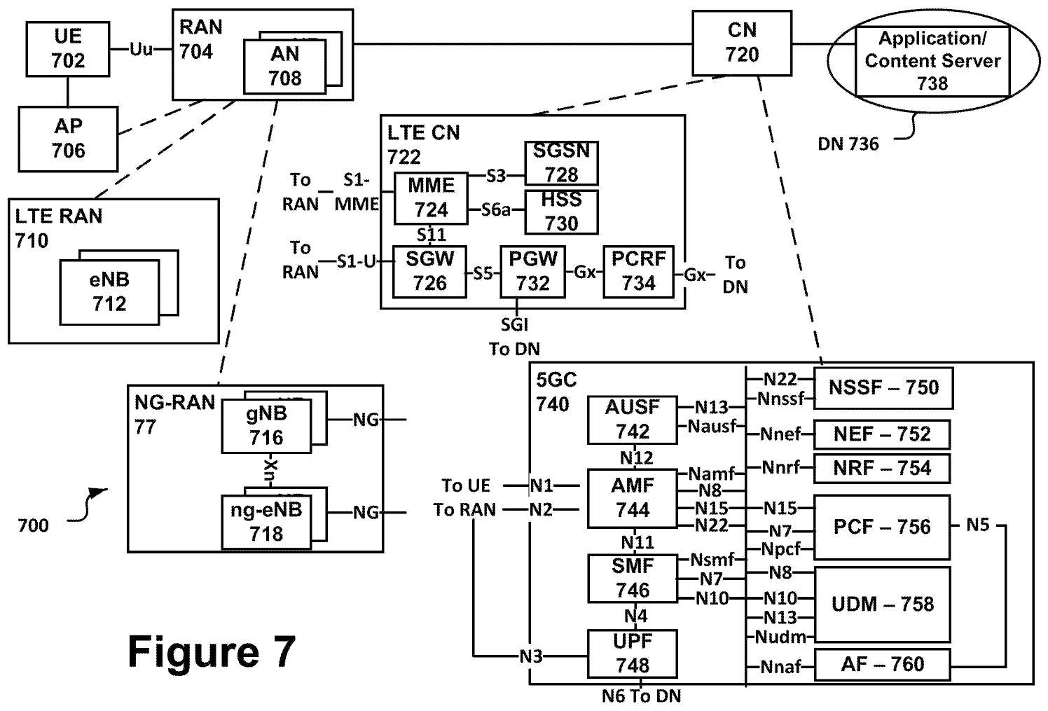

FIGS. 7-10 illustrate various systems, devices, and components that may implement aspects of disclosed embodiments.

FIG. 7 illustrates a network 700 in accordance with various embodiments. The network 700 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 700 may include a UE 702, which may include any mobile or non-mobile computing device designed to communicate with a RAN 704 via an over-the-air connection. The UE 702 may be communicatively coupled with the RAN 704 by a Uu interface. The UE 702 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 700 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 702 may additionally communicate with an AP 706 via an over-the-air connection. The AP 706 may manage a WLAN connection, which may serve to offload some/all network traffic from the RAN 704. The connection between the UE 702 and the AP 706 may be consistent with any IEEE 802.11 protocol, wherein the AP 706 could be a wireless fidelity (Wi-Fi®) router. In some embodiments, the UE 702, RAN 704, and AP 706 may utilize cellular-WLAN aggregation (for example, LWA/LWIP). Cellular-WLAN aggregation may involve the UE 702 being configured by the RAN 704 to utilize both cellular radio resources and WLAN resources.

The RAN 704 may include one or more access nodes, for example, AN 708. AN 708 may terminate air-interface protocols for the UE 702 by providing access stratum protocols including RRC, PDCP, RLC, MAC, and L1 protocols. In this manner, the AN 708 may enable data/voice connectivity between CN 720 and the UE 702. In some embodiments, the AN 708 may be implemented in a discrete device or as one or more software entities running on server computers as part of, for example, a virtual network, which may be referred to as a CRAN or virtual baseband unit pool. The AN 708 be referred to as a BS, gNB, RAN node, eNB, ng-eNB, NodeB, RSU, TRxP, TRP, etc. The AN 708 may be a macrocell base station or a low power base station for providing femtocells, picocells or other like cells having smaller coverage areas, smaller user capacity, or higher bandwidth compared to macrocells.

In embodiments in which the RAN 704 includes a plurality of ANs, they may be coupled with one another via an X2 interface (if the RAN 704 is an LTE RAN) or an Xn interface (if the RAN 704 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 704 may each manage one or more cells, cell groups, component carriers, etc. to provide the UE 702 with an air interface for network access. The UE 702 may be simultaneously connected with a plurality of cells provided by the same or different ANs of the RAN 704. For example, the UE 702 and RAN 704 may use carrier aggregation to allow the UE 702 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 704 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 702 or AN 708 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 704 may be an LTE RAN 710 with eNBs, for example, eNB 712. The LTE RAN 710 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 704 may be an NG-RAN 714 with gNBs, for example, gNB 716, or ng-eNBs, for example, ng-eNB 718. The gNB 716 may connect with 5G-enabled UEs using a 5G NR interface. The gNB 716 may connect with a 5G core through an NG interface, which may include an N2 interface or an N3 interface. The ng-eNB 718 may also connect with the 5G core through an NG interface, but may connect with a UE via an LTE air interface. The gNB 716 and the ng-eNB 718 may connect with each other over an Xn interface.

In some embodiments, the NG interface may be split into two parts, an NG user plane (NG-U) interface, which carries traffic data between the nodes of the NG-RAN 714 and a UPF 748 (e.g., N3 interface), and an NG control plane (NG-C) interface, which is a signaling interface between the nodes of the NG-RAN714 and an AMF 744 (e.g., N2 interface).

The NG-RAN 714 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 702 can be configured with multiple BWPs where each BWP configuration has a different SCS. When a BWP change is indicated to the UE 702, the SCS of the transmission is changed as well. Another use case example of BWP is related to power saving. In particular, multiple BWPs can be configured for the UE 702 with different amount of frequency resources (for example, PRBs) to support data transmission under different traffic loading scenarios. A BWP containing a smaller number of PRBs can be used for data transmission with small traffic load while allowing power saving at the UE 702 and in some cases at the gNB 716. A BWP containing a larger number of PRBs can be used for scenarios with higher traffic load.

The RAN 704 is communicatively coupled to CN 720 that includes network elements to provide various functions to support data and telecommunications services to customers/subscribers (for example, users of UE 702). The components of the CN 720 may be implemented in one physical node or separate physical nodes. In some embodiments, NFV may be utilized to virtualize any or all of the functions provided by the network elements of the CN 720 onto physical compute/storage resources in servers, switches, etc. A logical instantiation of the CN 720 may be referred to as a network slice, and a logical instantiation of a portion of the CN 720 may be referred to as a network sub-slice.

In some embodiments, the CN 720 may be an LTE CN 722, which may also be referred to as an EPC. The LTE CN 722 may include MME 724, SGW 726, SGSN 728, HSS 730, PGW 732, and PCRF 734 coupled with one another over interfaces (or “reference points”) as shown. Functions of the elements of the LTE CN 722 may be briefly introduced as follows.

The MME 724 may implement mobility management functions to track a current location of the UE 702 to facilitate paging, bearer activation/deactivation, handovers, gateway selection, authentication, etc.

The SGW 726 may terminate an Si interface toward the RAN and route data packets between the RAN and the LTE CN 722. The SGW 726 may be a local mobility anchor point for inter-RAN node handovers and also may provide an anchor for inter-3GPP mobility. Other responsibilities may include lawful intercept, charging, and some policy enforcement.

The SGSN 728 may track a location of the UE 702 and perform security functions and access control. In addition, the SGSN 728 may perform inter-EPC node signaling for mobility between different RAT networks; PDN and S-GW selection as specified by MME 724; MME selection for handovers; etc. The S3 reference point between the MME 724 and the SGSN 728 may enable user and bearer information exchange for inter-3GPP access network mobility in idle/active states.

The HSS 730 may include a database for network users, including subscription-related information to support the network entities' handling of communication sessions. The HSS 730 can provide support for routing/roaming, authentication, authorization, naming/addressing resolution, location dependencies, etc. An S6a reference point between the HSS 730 and the MME 724 may enable transfer of subscription and authentication data for authenticating/authorizing user access to the LTE CN 720.

The PGW 732 may terminate an SGi interface toward a data network (DN) 736 that may include an application/content server 738. The PGW 732 may route data packets between the LTE CN 722 and the data network 736. The PGW 732 may be coupled with the SGW 726 by an S5 reference point to facilitate user plane tunneling and tunnel management. The PGW 732 may further include a node for policy enforcement and charging data collection (for example, PCEF). Additionally, the SGi reference point between the PGW 732 and the data network 736 may be an operator external public, a private PDN, or an intra-operator packet data network, for example, for provision of IMS services. The PGW 732 may be coupled with a PCRF 734 via a Gx reference point.

The PCRF 734 is the policy and charging control element of the LTE CN 722. The PCRF 734 may be communicatively coupled to the app/content server 738 to determine appropriate QoS and charging parameters for service flows. The PCRF 732 may provision associated rules into a PCEF (via Gx reference point) with appropriate TFT and QCI.

In some embodiments, the CN 720 may be a 5GC 740. The 5GC 740 may include an AUSF 742, AMF 744, SMF 746, UPF 748, NSSF 750, NEF 752, NRF 754, PCF 756, UDM 758, and AF 760 coupled with one another over interfaces (or “reference points”) as shown. Functions of the elements of the 5GC 740 may be briefly introduced as follows.

The AUSF 742 may store data for authentication of UE 702 and handle authentication-related functionality. The AUSF 742 may facilitate a common authentication framework for various access types. In addition to communicating with other elements of the 5GC 740 over reference points as shown, the AUSF 742 may exhibit an Nausf service-based interface.

The AMF 744 may allow other functions of the 5GC 740 to communicate with the UE 702 and the RAN 704 and to subscribe to notifications about mobility events with respect to the UE 702. The AMF 744 may be responsible for registration management (for example, for registering UE 702), connection management, reachability management, mobility management, lawful interception of AMF-related events, and access authentication and authorization. The AMF 744 may provide transport for SM messages between the UE 702 and the SMF 746, and act as a transparent proxy for routing SM messages. AMF 744 may also provide transport for SMS messages between UE 702 and an SMSF. AMF 744 may interact with the AUSF 742 and the UE 702 to perform various security anchor and context management functions. Furthermore, AMF 744 may be a termination point of a RAN CP interface, which may include or be an N2 reference point between the RAN 704 and the AMF 744; and the AMF 744 may be a termination point of NAS (N1) signaling, and perform NAS ciphering and integrity protection. AMF 744 may also support NAS signaling with the UE 702 over an N3 IWF interface.

The SMF 746 may be responsible for SM (for example, session establishment, tunnel management between UPF 748 and AN 708); UE IP address allocation and management (including optional authorization); selection and control of UP function; configuring traffic steering at UPF 748 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 744 over N2 to AN 708; and determining SSC mode of a session. SM may refer to management of a PDU session, and a PDU session or “session” may refer to a PDU connectivity service that provides or enables the exchange of PDUs between the UE 702 and the data network 736.

The UPF 748 may act as an anchor point for intra-RAT and inter-RAT mobility, an external PDU session point of interconnect to data network 736, and a branching point to support multi-homed PDU session. The UPF 748 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 748 may include an uplink classifier to support routing traffic flows to a data network.

The NSSF 750 may select a set of network slice instances serving the UE 702. The NSSF 750 may also determine allowed NSSAI and the mapping to the subscribed S-NSSAIs, if needed. The NSSF 750 may also determine the AMF set to be used to serve the UE 702, or a list of candidate AMFs based on a suitable configuration and possibly by querying the NRF 754. The selection of a set of network slice instances for the UE 702 may be triggered by the AMF 744 with which the UE 702 is registered by interacting with the NSSF 750, which may lead to a change of AMF. The NSSF 750 may interact with the AMF 744 via an N22 reference point; and may communicate with another NSSF in a visited network via an N31 reference point (not shown). Additionally, the NSSF 750 may exhibit an Nnssf service-based interface.

The NEF 752 may securely expose services and capabilities provided by 3GPP network functions for third party, internal exposure/re-exposure, AFs (e.g., AF 760), edge computing or fog computing systems, etc. In such embodiments, the NEF 752 may authenticate, authorize, or throttle the AFs. NEF 752 may also translate information exchanged with the AF 760 and information exchanged with internal network functions. For example, the NEF 752 may translate between an AF-Service-Identifier and an internal 5GC information. NEF 752 may also receive information from other NFs based on exposed capabilities of other NFs. This information may be stored at the NEF 752 as structured data, or at a data storage NF using standardized interfaces. The stored information can then be re-exposed by the NEF 752 to other NFs and AFs, or used for other purposes such as analytics. Additionally, the NEF 752 may exhibit an Nnef service-based interface.

The NRF 754 may support service discovery functions, receive NF discovery requests from NF instances, and provide the information of the discovered NF instances to the NF instances. NRF 754 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 754 may exhibit the Nnrf service-based interface.

The PCF 756 may provide policy rules to control plane functions to enforce them, and may also support unified policy framework to govern network behavior. The PCF 756 may also implement a front end to access subscription information relevant for policy decisions in a UDR of the UDM 758. In addition to communicating with functions over reference points as shown, the PCF 756 exhibit an Npcf service-based interface.

The UDM 758 may handle subscription-related information to support the network entities' handling of communication sessions, and may store subscription data of UE 702. For example, subscription data may be communicated via an N8 reference point between the UDM 758 and the AMF 744. The UDM 758 may include two parts, an application front end and a UDR. The UDR may store subscription data and policy data for the UDM 758 and the PCF 756, and/or structured data for exposure and application data (including PFDs for application detection, application request information for multiple UEs 702) for the NEF 752. The Nudr service-based interface may be exhibited by the UDR 221 to allow the UDM 758, PCF 756, and NEF 752 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 758 may exhibit the Nudm service-based interface.

The AF 760 may provide application influence on traffic routing, provide access to NEF, and interact with the policy framework for policy control.

In some embodiments, the 5GC 740 may enable edge computing by selecting operator/3^{rd} party services to be geographically close to a point that the UE 702 is attached to the network. This may reduce latency and load on the network. To provide edge-computing implementations, the 5GC 740 may select a UPF 748 close to the UE 702 and execute traffic steering from the UPF 748 to data network 736 via the N6 interface. This may be based on the UE subscription data, UE location, and information provided by the AF 760. In this way, the AF 760 may influence UPF (re)selection and traffic routing. Based on operator deployment, when AF 760 is considered to be a trusted entity, the network operator may permit AF 760 to interact directly with relevant NFs. Additionally, the AF 760 may exhibit an Naf service-based interface.

The data network 736 may represent various network operator services, Internet access, or third party services that may be provided by one or more servers including, for example, application/content server 738.

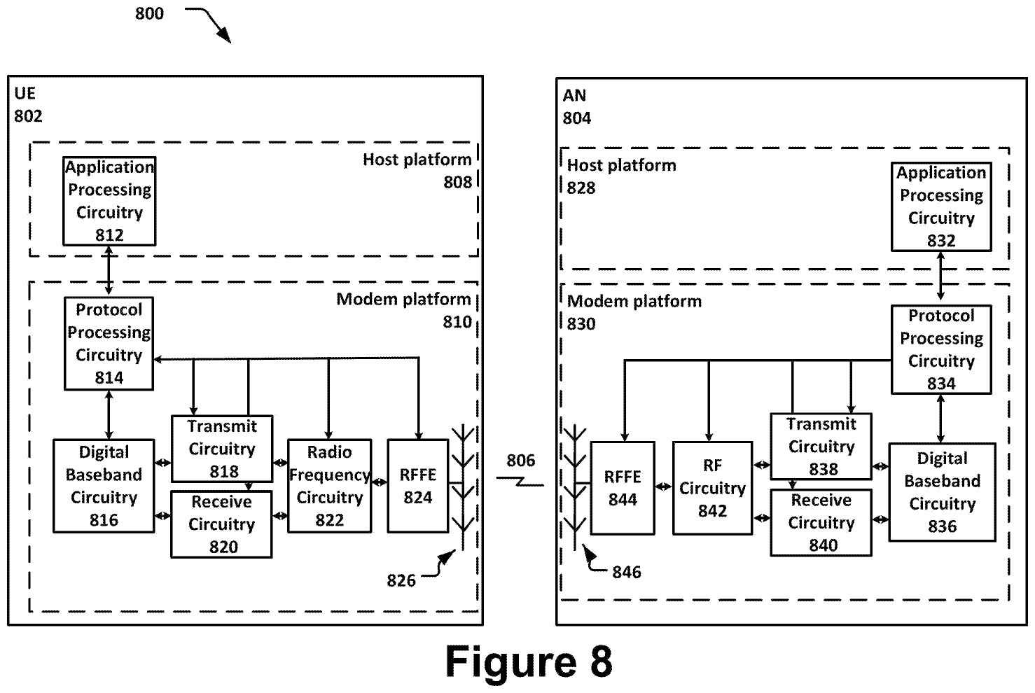

FIG. 8 schematically illustrates a wireless network 800 in accordance with various embodiments. The wireless network 800 may include a UE 802 in wireless communication with an AN 804. The UE 802 and AN 804 may be similar to, and substantially interchangeable with, like-named components described elsewhere herein.

The UE 802 may be communicatively coupled with the AN 804 via connection 806. The connection 806 is illustrated as an air interface to enable communicative coupling, and can be consistent with cellular communications protocols such as an LTE protocol or a 5G NR protocol operating at mmWave or sub-6 GHz frequencies.

The UE 802 may include a host platform 808 coupled with a modem platform 810. The host platform 808 may include application processing circuitry 812, which may be coupled with protocol processing circuitry 814 of the modem platform 810. The application processing circuitry 812 may run various applications for the UE 802 that source/sink application data. The application processing circuitry 812 may further implement one or more layer operations to transmit/receive application data to/from a data network. These layer operations may include transport (for example UDP) and Internet (for example, IP) operations

The protocol processing circuitry 814 may implement one or more of layer operations to facilitate transmission or reception of data over the connection 806. The layer operations implemented by the protocol processing circuitry 814 may include, for example, MAC, RLC, PDCP, RRC and NAS operations.

The modem platform 810 may further include digital baseband circuitry 816 that may implement one or more layer operations that are “below” layer operations performed by the protocol processing circuitry 814 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 810 may further include transmit circuitry 818, receive circuitry 820, RF circuitry 822, and RF front end (RFFE) 824, which may include or connect to one or more antenna panels 826. Briefly, the transmit circuitry 818 may include a digital-to-analog converter, mixer, intermediate frequency (IF) components, etc.; the receive circuitry 820 may include an analog-to-digital converter, mixer, IF components, etc.; the RF circuitry 822 may include a low-noise amplifier, a power amplifier, power tracking components, etc.; RFFE 824 may include filters (for example, surface/bulk acoustic wave filters), switches, antenna tuners, beamforming components (for example, phase-array antenna components), etc. The selection and arrangement of the components of the transmit circuitry 818, receive circuitry 820, RF circuitry 822, RFFE 824, and antenna panels 826 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 814 may include one or more instances of control circuitry (not shown) to provide control functions for the transmit/receive components.

A UE reception may be established by and via the antenna panels 826, RFFE 824, RF circuitry 822, receive circuitry 820, digital baseband circuitry 816, and protocol processing circuitry 814. In some embodiments, the antenna panels 826 may receive a transmission from the AN 804 by receive-beamforming signals received by a plurality of antennas/antenna elements of the one or more antenna panels 826.

A UE transmission may be established by and via the protocol processing circuitry 814, digital baseband circuitry 816, transmit circuitry 818, RF circuitry 822, RFFE 824, and antenna panels 826. In some embodiments, the transmit components of the UE 804 may apply a spatial filter to the data to be transmitted to form a transmit beam emitted by the antenna elements of the antenna panels 826.

Similar to the UE 802, the AN 804 may include a host platform 828 coupled with a modem platform 830. The host platform 828 may include application processing circuitry 832 coupled with protocol processing circuitry 834 of the modem platform 830. The modem platform may further include digital baseband circuitry 836, transmit circuitry 838, receive circuitry 840, RF circuitry 842, RFFE circuitry 844, and antenna panels 846. The components of the AN 804 may be similar to and substantially interchangeable with like-named components of the UE 802. In addition to performing data transmission/reception as described above, the components of the AN 808 may perform various logical functions that include, for example, RNC functions such as radio bearer management, uplink and downlink dynamic radio resource management, and data packet scheduling.

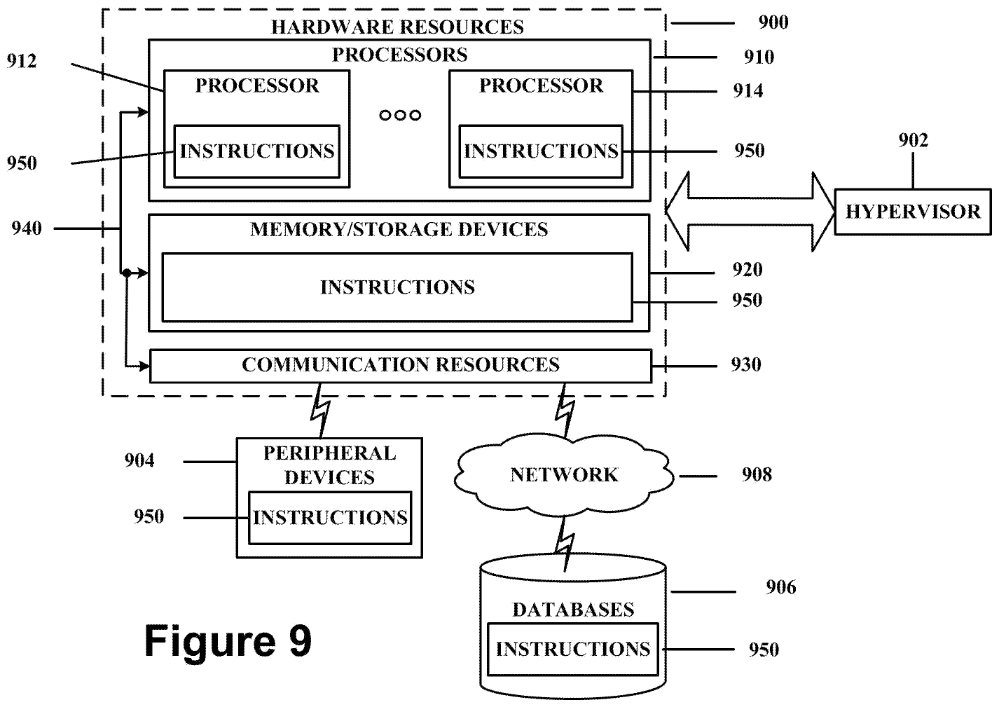

FIG. 9 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940 or other interface circuitry. For embodiments where node virtualization (e.g., NFV) is utilized, a hypervisor 902 may be executed to provide an execution environment for one or more network slices/sub-slices to utilize the hardware resources 900.

The processors 910 may include, for example, a processor 912 and a processor 914. The processors 910 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 920 may include main memory, disk storage, or any suitable combination thereof. The memory/storage devices 920 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 930 may include interconnection or network interface controllers, components, or other suitable devices to communicate with one or more peripheral devices 904 or one or more databases 906 or other network elements via a network 908. For example, the communication resources 930 may include wired communication components (e.g., for coupling via USB, Ethernet, etc.), cellular communication components, NFC components, Bluetooth® (or Bluetooth® Low Energy) components, Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

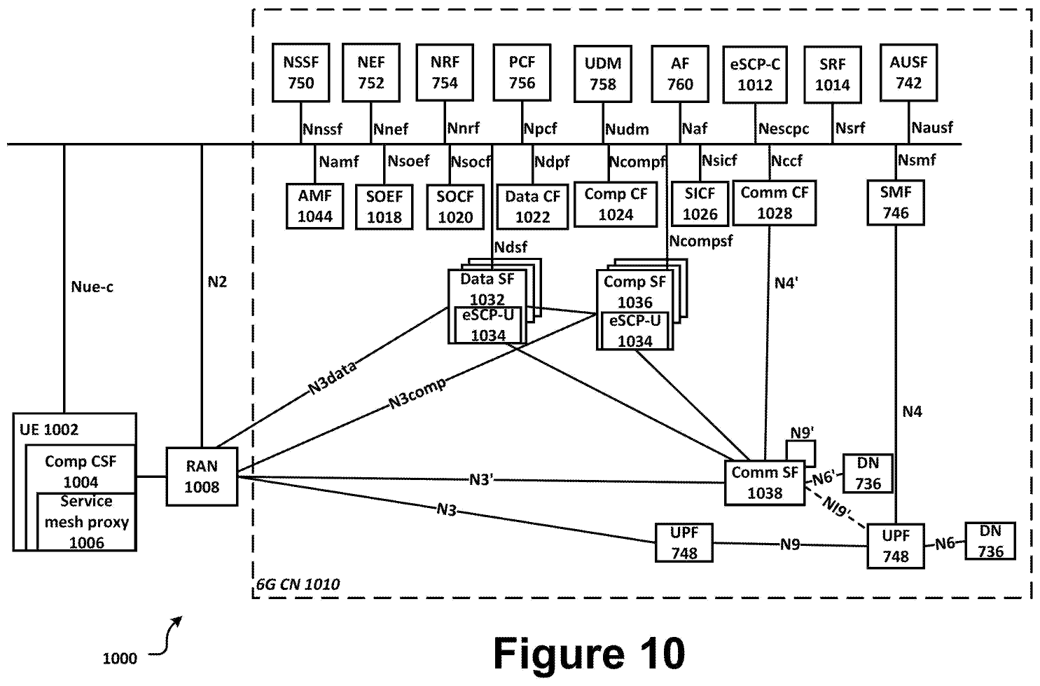

FIG. 10 illustrates a network 1000 in accordance with various embodiments. The network 1000 may operate in a matter consistent with 3GPP technical specifications or technical reports for 6G systems. In some embodiments, the network 1000 may operate concurrently with network 700. For example, in some embodiments, the network 1000 may share one or more frequency or bandwidth resources with network 700. As one specific example, a UE (e.g., UE 1002) may be configured to operate in both network 1000 and network 700. Such configuration may be based on a UE including circuitry configured for communication with frequency and bandwidth resources of both networks 700 and 1000. In general, several elements of network 1000 may share one or more characteristics with elements of network 700. For the sake of brevity and clarity, such elements may not be repeated in the description of network 1000.

The network 1000 may include a UE 1002, which may include any mobile or non-mobile computing device designed to communicate with a RAN 1008 via an over-the-air connection. The UE 1002 may be similar to, for example, UE 702. The UE 1002 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 10, in some embodiments the network 1000 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 10, the UE 1002 may be communicatively coupled with an AP such as AP 706 as described with respect to FIG. 7. Additionally, although not specifically shown in FIG. 10, in some embodiments the RAN 1008 may include one or more ANss such as AN 708 as described with respect to FIG. 7. The RAN 1008 and/or the AN of the RAN 1008 may be referred to as a base station (BS), a RAN node, or using some other term or name.

The UE 1002 and the RAN 1008 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1008 may allow for communication between the UE 1002 and a 6G core network (CN) 1010. Specifically, the RAN 1008 may facilitate the transmission and reception of data between the UE 1002 and the 6G CN 1010. The 6G CN 1010 may include various functions such as NSSF 750, NEF 752, NRF 754, PCF 756, UDM 758, AF 760, SMF 746, and AUSF 742. The 6G CN 1010 may additional include UPF 748 and DN 736 as shown in FIG. 10.

Additionally, the RAN 1008 may include various additional functions that are in addition to, or alternative to, functions of a legacy cellular network such as a 4G or 5G network. Two such functions may include a Compute Control Function (Comp CF) 1024 and a Compute Service Function (Comp SF) 1036. The Comp CF 1024 and the Comp SF 1036 may be parts or functions of the Computing Service Plane. Comp CF 1024 may be a control plane function that provides functionalities such as management of the Comp SF 1036, computing task context generation and management (e.g., create, read, modify, delete), interaction with the underlaying computing infrastructure for computing resource management, etc. Comp SF 1036 may be a user plane function that serves as the gateway to interface computing service users (such as UE 1002) and computing nodes behind a Comp SF instance. Some functionalities of the Comp SF 1036 may include: parse computing service data received from users to compute tasks executable by computing nodes; hold service mesh ingress gateway or service API gateway; service and charging policies enforcement; performance monitoring and telemetry collection, etc. In some embodiments, a Comp SF 1036 instance may serve as the user plane gateway for a cluster of computing nodes. A Comp CF 1024 instance may control one or more Comp SF 1036 instances.

Two other such functions may include a Communication Control Function (Comm CF) 1028 and a Communication Service Function (Comm SF) 1038, which may be parts of the Communication Service Plane. The Comm CF 1028 may be the control plane function for managing the Comm SF 1038, communication sessions creation/configuration/releasing, and managing communication session context. The Comm SF 1038 may be a user plane function for data transport. Comm CF 1028 and Comm SF 1038 may be considered as upgrades of SMF 746 and UPF 748, which were described with respect to a 5G system in FIG. 7. The upgrades provided by the Comm CF 1028 and the Comm SF 1038 may enable service-aware transport. For legacy (e.g., 4G or 5G) data transport, SMF 746 and UPF 748 may still be used.

Two other such functions may include a Data Control Function (Data CF) 1022 and Data Service Function (Data SF) 1032 may be parts of the Data Service Plane. Data CF 1022 may be a control plane function and provides functionalities such as Data SF 1032 management, Data service creation/configuration/releasing, Data service context management, etc. Data SF 1032 may be a user plane function and serve as the gateway between data service users (such as UE 1002 and the various functions of the 6G CN 1010) and data service endpoints behind the gateway. Specific functionalities may include include: parse data service user data and forward to corresponding data service endpoints, generate charging data, report data service status.

Another such function may be the Service Orchestration and Chaining Function (SOCF) 1020, which may discover, orchestrate and chain up communication/computing/data services provided by functions in the network. Upon receiving service requests from users, SOCF 1020 may interact with one or more of Comp CF 1024, Comm CF 1028, and Data CF 1022 to identify Comp SF 1036, Comm SF 1038, and Data SF 1032 instances, configure service resources, and generate the service chain, which could contain multiple Comp SF 1036, Comm SF 1038, and Data SF 1032 instances and their associated computing endpoints. Workload processing and data movement may then be conducted within the generated service chain. The SOCF 1020 may also responsible for maintaining, updating, and releasing a created service chain.

Another such function may be the service registration function (SRF) 1014, which may act as a registry for system services provided in the user plane such as services provided by service endpoints behind Comp SF 1036 and Data SF 1032 gateways and services provided by the UE 1002. The SRF 1014 may be considered a counterpart of NRF 754, which may act as the registry for network functions.

Other such functions may include an evolved service communication proxy (eSCP) and service infrastructure control function (SICF) 1026, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1012 and eSCP-U 1034, for control plane service communication proxy and user plane service communication proxy, respectively. The SICF 1026 may control and configure eCSP instances in terms of service traffic routing policies, access rules, load balancing configurations, performance monitoring, etc.

Another such function is the AMF 1044. The AMF 1044 may be similar to 744, but with additional functionality. Specifically, the AMF 1044 may include potential functional repartition, such as move the message forwarding functionality from the AMF 1044 to the RAN 1008.

Another such function is the service orchestration exposure function (SOEF) 1018. The SOEF may be configured to expose service orchestration and chaining services to external users such as applications.

The UE 1002 may include an additional function that is referred to as a computing client service function (comp CSF) 1004. The comp CSF 1004 may have both the control plane functionalities and user plane functionalities, and may interact with corresponding network side functions such as SOCF 1020, Comp CF 1024, Comp SF 1036, Data CF 1022, and/or Data SF 1032 for service discovery, request/response, compute task workload exchange, etc. The Comp CSF 1004 may also work with network side functions to decide on whether a computing task should be run on the UE 1002, the RAN 1008, and/or an element of the 6G CN 1010.

The UE 1002 and/or the Comp CSF 1004 may include a service mesh proxy 1006. The service mesh proxy 1006 may act as a proxy for service-to-service communication in the user plane. Capabilities of the service mesh proxy 1006 may include one or more of addressing, security, load balancing, etc.

### EXAMPLE PROCEDURES

In some embodiments, the electronic device(s), network(s), system(s), chip(s) or component(s), or portions or implementations thereof, of FIGS. 7-10, or some other figure herein, may be configured to perform one or more processes, techniques, or methods as described herein, or portions thereof. For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

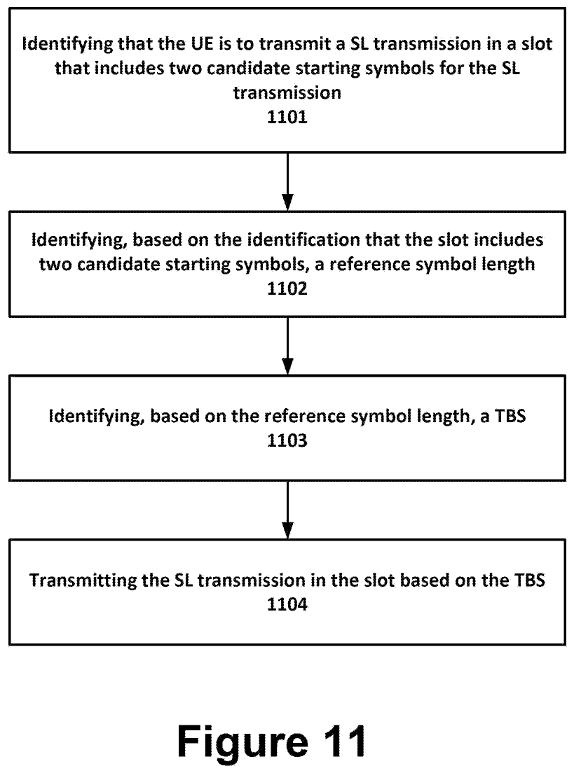

FIG. 11 depicts one specific example of such a process. Specifically, the process of FIG. 11 may include or relate to a method to be performed by a user equipment (UE), one or more elements of a UE, and/or one or more electronic devices that include and/or implement a UE. The process may include identifying, at 1101, that the UE is to transmit a sidelink (SL) transmission in a slot that includes two candidate starting symbols for the SL transmission; identifying, at 1102 based on the identification that the slot includes two candidate starting symbols, a reference symbol length; identifying, at 1103 based on the reference symbol length, a transport block size (TBS); and transmitting, at 1104, the SL transmission in the slot based on the TBS.

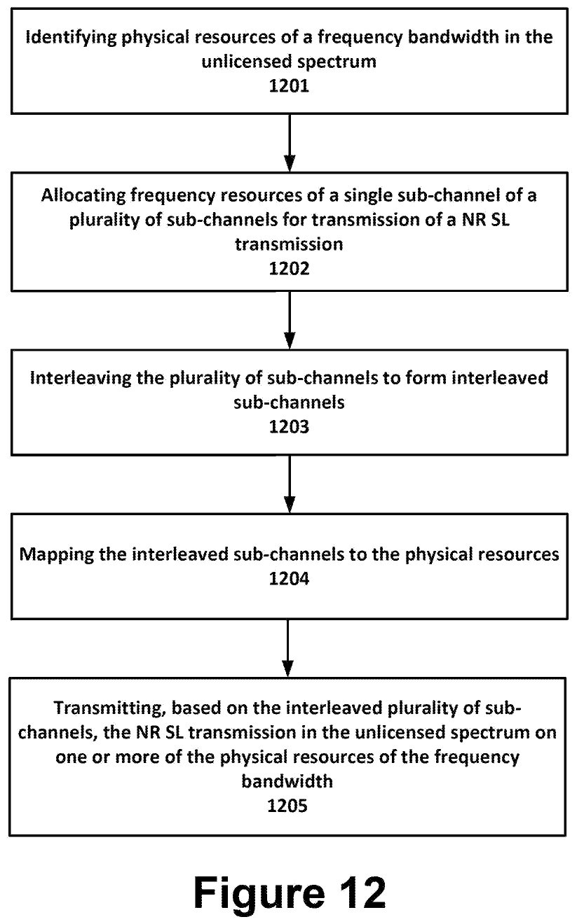

Another such process is depicted in FIG. 12. Specifically, the process of FIG. 12 may include or relate to a method to be performed by a user equipment (UE), one or more elements of a UE, and/or one or more electronic devices that include and/or implement a UE. The process may include identifying, at 1201, physical resources of a frequency bandwidth in the unlicensed spectrum; allocating, at 1202, frequency resources of a single sub-channel of a plurality of sub-channels for transmission of a new radio (NR) sidelink (SL) transmission; interleaving, at 1203, the plurality of sub-channels to form interleaved sub-channels; mapping, at 1204, the interleaved sub-channels to the physical resources; and transmitting, at 1205 based on the interleaved plurality of sub-channels, the NR SL transmission in the unlicensed spectrum on one or more of the physical resources of the frequency bandwidth.

### Examples

Example 1 may include sidelink control channel structure for wideband control channel transmissions

Example 2 may include sidelink control channel structure for interleave transmissions

Example 3 may include the sidelink control channel structure for different OFDM symbol starting times

Example 4 may include the standalone sidelink control channel structure

Example 5 may include the single stage sidelink control channel structure

Example 6 may include two stage sidelink control channel structure

Example 7 may include a method of operating a wireless network, the method including any of the above enhancements related to physical sidelink (SL) shared channel transmission when an SL system operates in unlicensed spectrum.

Example 8 may include the method of example 7 and/or some other example herein, wherein an enhanced SL shared channel structure to adapt to the LBT requirements is provided;

Example 9 may include the method of example 7 and/or some other example herein, wherein an enhanced SL shared channel structure that can allocate any number of OFDM symbols in a slot is provided;

Example 10 may include the method of example 7 and/or some other example herein, wherein an enhanced SL shared channel DMRS time density signaling scheme for a SL system operating in unlicensed spectrum is provided;

Example 11 may include the method of example 7 and/or some other example herein, wherein an enhanced SL shared channel TBS determination scheme for a SL system operating in unlicensed spectrum is provided.

Example 12 includes a method of a user equipment (UE) comprising: initiating a sidelink (SL) transmission at any one of a plurality of symbols within a first slot, wherein the SL transmission spans at least one slot boundary; and ending the SL transmission within a second slot.

Example 13 includes a method of a UE comprising: initiating a sidelink (SL) transmission at a pre-configured symbol within a first slot, wherein the SL transmission is contained within the first slot or spans at least one slot boundary; and ending the SL transmission within the first slot in response to the SL transmission being contained within the first slot, or ending the SL transmission within a second slot in response to the SL transmission spanning at least one slot boundary.

Example 14 includes the method of examples 12 or 13, and/or some other example herein, wherein ending the SL transmission includes ending the SL transmission before a last symbol in a slot which the UE is continuously transmitting

Example 15 includes the method of any of examples 12-14, and/or some other example herein, wherein ending the SL transmission includes leaving a second-to-last symbol to be used for Tx/Rx switching and as an LBT gap to allow other UEs to potentially start a SL transition in a following slot.

Example 16 includes the method of any of examples 12-15, and/or some other example herein, wherein ending the SL transmission includes ending the SL transmission at an OFDM symbol or time within a slot that is enabling a Tx/Rx switching gap to the start of a physical sidelink feedback channel (PSFCH) transmission.

Example 17 includes the method of any of examples 12-16, and/or some other example herein, wherein ending the SL transmission includes ending the SL transmission at an arbitrary symbol within a slot, a predefined symbol within a slot, or at one of a plurality of predefined set of symbols in a slot.

Example 18 includes the method of any of examples 12-17, and/or some other example herein, wherein the SL transmission is a physical sidelink shared channel (PSSCH) transmission, and sub-channels are allocated for the PSSCH transmission by direct mapping to physical resources or by an interlaced mapping of physical resource blocks (PRBs) belonging to a single sub-channel.

Example 19 includes the method of any of examples 12-18, and/or some other example herein, wherein the SL transmission is a physical sidelink shared channel (PSSCH) transmission, and sub-channels are allocated for the PSSCH transmission via a wideband interlaced allocation.

Example 20 includes the method of any of examples 12-19, and/or some other example herein, wherein the SL transmission is a physical sidelink shared channel (PSSCH) transmission, and sub-channels are allocated for the PSSCH transmission via a wideband contiguous allocation.

Example 21 includes the method of any of examples 12-20, and/or some other example herein, wherein the SL transmission is a PSSCH transmission having a demodulation reference signal (DMRS) time density selected from a set of options preconfigured per resource pool, or configured per resource pool and no other time density can be dynamically changed.

Example 22 includes a method to be performed by a user equipment (UE), one or more elements of a UE, and/or one or more electronic devices that include and/or implement a UE, wherein the method comprises: identifying that the UE is to transmit a sidelink (SL) transmission in a slot that includes two candidate starting symbols for the SL transmission; identifying, based on the identification that the slot includes two candidate starting symbols, a reference symbol length; identifying, based on the reference symbol length, a transport block size (TBS); and transmitting the SL transmission in the slot based on the TBS.

Example 23 includes the method of example 22, and/or some other example herein, further comprising: identifying, based on a characteristic of the SL channel, the reference symbol length; and transmitting an indication of the reference symbol length.

Example 24 includes the method of any of examples 22-23, and/or some other example herein, wherein the reference symbol length is identified based on a first starting symbol of the two candidate starting symbols.

Example 25 includes the method of any of examples 22-23, and/or some other example herein, wherein the reference symbol length is identified based on a second starting symbol of the two candidate starting symbols.

Example 26 includes the method of any of examples 22-23, and/or some other example herein, wherein the reference symbol length is identified based on a pre-configured reference symbol length.

Example 27 includes the method of any of examples 22-26, and/or some other example herein, wherein the SL transmission is a physical SL control channel (PSCCH) transmission or a physical SL shared channel (PSSCH) transmission.

Example 28 includes the method of any of examples 22-27, and/or some other example herein, wherein a first starting symbol of the two candidate starting symbols is a symbol from the set of symbols {#0, #1, #2, #3, #4, #5, #6} of the slot.

Example 29 includes the method of any of examples 22-28, and/or some other example herein, wherein a second starting symbol of the two candidate starting symbols is a symbol from the set of symbols {#3, #4, #5, #6, #7} of the slot.

Example 30 includes the method of any of examples 22-29, and/or some other example herein, wherein a first starting symbol of the two candidate starting symbols is symbol #0 of the slot.

Example 31 includes the method of any of examples 22-30, and/or some other example herein, wherein if a second starting symbol of the two candidate starting symbols is used, then a number of symbols used for the SL transmission is greater than or equal to six.

Example 32 includes a method to be performed by a user equipment (UE), one or more elements of a UE, and/or one or more electronic devices that include and/or implement a UE, wherein the method comprises: identifying physical resources of a frequency bandwidth in the unlicensed spectrum; allocating frequency resources of a single sub-channel of a plurality of sub-channels for transmission of a new radio (NR) sidelink (SL) transmission; interleaving the plurality of sub-channels to form interleaved sub-channels; mapping the interleaved sub-channels to the physical resources; and transmitting, based on the interleaved plurality of sub-channels, the NR SL transmission in the unlicensed spectrum on one or more of the physical resources of the frequency bandwidth.

Example 33 includes the method of example 32, and/or some other example herein, wherein the SL transmission is a physical SL control channel (PSCCH) transmission.

Example 34 includes the method of any of examples 32-33, and/or some other example herein, wherein the SL transmission occupies two consecutive symbols or three consecutive symbols of the physical resources.

Example 35 includes the method of any of examples 32-34, and/or some other example herein, wherein the sub-channel is a lowest sub-channel of the plurality of sub-channels.

Example 36 includes the method of any of examples 32-35, and/or some other example herein, wherein the interleaving is resource block (RB)-based interleaving.

Example 37 includes the method of any of examples 32-36, and/or some other example herein, wherein the SL transmission is transmitted over a plurality of slots.

Example 38 includes the method of example 37, and/or some other example herein, wherein the SL transmission is a PSSCH transmission or a PSCCH transmission.

Example Z01 may include an apparatus comprising means to perform one or more elements of a method described in or related to any of examples 1-38, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-38, or any other method or process described herein.

Example Z03 may include an apparatus comprising logic, modules, or circuitry to perform one or more elements of a method described in or related to any of examples 1-38, or any other method or process described herein.

Example Z04 may include a method, technique, or process as described in or related to any of examples 1-38, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-38, or portions thereof.

Example Z06 may include a signal as described in or related to any of examples 1-38, or portions or parts thereof.

Example Z07 may include a datagram, packet, frame, segment, protocol data unit (PDU), or message as described in or related to any of examples 1-38, or portions or parts thereof, or otherwise described in the present disclosure.

Example Z08 may include a signal encoded with data as described in or related to any of examples 1-38, or portions or parts thereof, or otherwise described in the present disclosure.

Example Z09 may include a signal encoded with a datagram, packet, frame, segment, protocol data unit (PDU), or message as described in or related to any of examples 1-38, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-38, or portions thereof.

Example Z11 may include a computer program comprising instructions, wherein execution of the program by a processing element is to cause the processing element to carry out the method, techniques, or process as described in or related to any of examples 1-38, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation |
| | Partnership |
| | Project |
| 4G | Fourth |
| | Generation |
| 5G | Fifth Generation |
| 5GC | 5G Core network |
| AC | Application |
| | Client |
| ACR | Application |
| | Context Relocation |
| ACK | Acknowledgement |
| ACID | Application |
| | Client Identification |
| AF | Application |
| | Function |
| AM | Acknowledged |
| | Mode |
| AMBR | Aggregate |
| | Maximum Bit Rate |
| AMF | Access and |
| | Mobility |
| | Management |
| | Function |
| AN | Access Network |
| ANR | Automatic |
| | Neighbour Relation |
| AOA | Angle of |
| | Arrival |
| AP | Application |
| | Protocol, |
| | Antenna |
| | Port, Access Point |
| API | Application |
| | Programming Interface |
| APN | Access Point |
| | Name |
| ARP | Allocation and |
| | Retention Priority |
| ARQ | Automatic Repeat |
| | Request |
| AS | Access Stratum |
| ASP | Application Service |
| | Provider |
| ASN.1 | Abstract Syntax |
| | Notation One |
| AUSF | Authentication |
| | Server Function |
| AWGN | Additive |
| | White Gaussian |
| | Noise |
| BAP | Backhaul |
| | Adaptation Protocol |
| BCH | Broadcast |
| | Channel |
| BER | Bit Error Ratio |
| BFD | Beam |
| | Failure Detection |
| BLER | Block Error Rate |
| BPSK | Binary Phase |
| | Shift Keying |
| BRAS | Broadband |
| | Remote Access |
| | Server |
| BSS | Business Support |
| | System |
| BS | Base Station |
| BSR | Buffer Status |
| | Report |
| BW | Bandwidth |
| BWP | Bandwidth Part |
| C-RNTI | Cell Radio |
| | Network |
| | Temporary |
| | Identity |
| CA | Carrier |
| | Aggregation, |
| | Certification |
| | Authority |
| CAPEX | CAPital |
| | EXpenditure |
| CBRA | Contention Based |
| | Random Access |
| CC | Component |
| | Carrier, Country |
| | Code, Cryptographic |
| | Checksum |
| CCA | Clear Channel |
| | Assessment |
| CCE | Control Channel |
| | Element |
| CCCH | Common Control |
| | Channel |
| CE | Coverage |
| | Enhancement |
| CDM | Content Delivery |
| | Network |
| CDMA | Code- |
| | Division Multiple |
| | Access |
| CDR | Charging Data |
| | Request |
| CDR | Charging Data |
| | Response |
| CFRA | Contention Free |
| | Random |
| | Access |
| CG | Cell Group |
| CGF | Charging |
| | Gateway Function |
| CHF | Charging |
| | Function |
| CI | Cell Identity |
| CID | Cell-ID (e.g., |
| | positioning |
| | method) |
| CIM | Common |
| | Information |
| | Model |
| CIR | Carrier to |
| | Interference Ratio |
| CK | Cipher Key |
| CM | Connection |
| | Management, |
| | Conditional |
| | Mandatory |
| CMAS | Commercial |
| | Mobile Alert Service |
| CMD | Command |
| CMS | Cloud |
| | Management System |
| CO | Conditional |
| | Optional |
| CoMP | Coordinated |
| | Multi-Point |
| CORESET | Control |
| | Resource Set |
| COTS | Commercial Off- |
| | The-Shelf |
| CP | Control Plane, |
| | Cyclic Prefix, |
| | Connection Point |
| CPD | Connection Point |
| | Descriptor |
| CPE | Customer |
| | Premise |
| | Equipment |
| CPICH | Common Pilot |
| | Channel |
| CQI | Channel Quality |
| | Indicator |
| CPU | CSI processing |
| | unit, Central |
| | Processing Unit |
| C/R | Command/Response |
| | field bit |
| CRAN | Cloud Radio |
| | Access Network, |
| | Cloud RAN |
| CRB | Common |
| | Resource Block |
| CRC | Cyclic |
| | Redundancy Check |
| CRI | Channel-State |
| | Information Resource |
| | Indicator, CSI-RS |
| | Resource |
| | Indicator |
| C-RNTI | Cell RNTI |
| CS | Circuit Switched |
| CSCF | call |
| | session control function |
| CSAR | Cloud Service |
| | Archive |
| CSI | Channel-State |
| | Information |
| CSI-IM | CSI |
| | Interference |
| | Measurement |
| CSI-RS | CSI |
| | Reference Signal |
| CSI-RSRP | CSI |
| | reference signal |
| | received power |
| CSI-RSRQ | CSI |
| | reference signal |
| | received quality |
| CSI-SINR | CSI |
| | signal-to-noise and |
| | interference ratio |
| CSMA | Carrier Sense |
| | Multiple |
| | Access |
| CSMA/CA | CSMA |
| | with collision avoidance |
| CSS | Common Search |
| | Space, Cell-specific |
| | Search Space |
| CTF | Charging |
| | Trigger Function |
| CTS | Clear-to-Send |
| CW | Codeword |
| CWS | Contention |
| | Window Size |
| D2D | Device-to-Device |
| DC | Dual |
| | Connectivity, Direct |
| | Current |
| DCI | Downlink Control |
| | Information |
| DF | Deployment |
| | Flavour |
| DL | Downlink |
| DMTF | Distributed |
| | Management |
| | Task |
| | Force |
| DPDK | Data Plane |
| | Development Kit |
| DM-RS, | DMRS |
| | Demodulation |
| | Reference Signal |
| DN | Data network |
| DNN | Data Network |
| | Name |
| DNAI | Data Network |
| | Access Identifier |
| DRB | Data Radio |
| | Bearer |
| DRS | Discovery |
| | Reference |
| | Signal |
| DRX | Discontinuous |
| | Reception |
| DSL | Domain Specific |
| | Language. Digital |
| | Subscriber Line |
| DSLAM | DSL |
| | Access Multiplexer |
| DwPTS | Downlink |
| | Pilot Time Slot |
| E-LAN | Ethernet |
| Local | Area Network |
| E2E | End-to-End |
| EAS | Edge Application |
| | Server |
| ECCA | extended clear |
| | channel |
| | assessment, |
| | extended CCA |
| ECCE | Enhanced Control |
| | Channel Element, |
| | Enhanced CCE |
| ED | Energy Detection |
| EDGE | Enhanced |
| | Datarates for GSM |
| | Evolution (GSM |
| | Evolution) |
| EAS | Edge |
| | Application Server |
| EASID | Edge |
| | Application Server |
| | Identification |
| ECS | Edge |
| | Configuration Server |
| ECSP | Edge |
| | Computing Service |
| | Provider |
| EDN | Edge Data |
| | Network |
| EEC | Edge |
| | Enabler Client |
| EECID | Edge |
| | Enabler Client |
| | Identification |
| EES | Edge |
| | Enabler Server |
| EESID | Edge |
| | Enabler Server |
| | Identification |
| EHE | Edge |
| | Hosting Environment |
| EGMF | Exposure |
| | Governance |
| | Management |
| | Function |
| EGPRS | Enhanced |
| | GPRS |
| EIR | Equipment |
| | Identity Register |
| eLAA | enhanced |
| | Licensed Assisted |
| | Access, enhanced |
| | LAA |
| EM | Element Manager |
| eMBB | Enhanced Mobile |
| | Broadband |
| EMS | Element |
| | Management System |
| eNB | evolved NodeB, |
| | E-UTRAN Node B |
| | EN-DC E-UTRA- |
| | NR Dual |
| | Connectivity |
| EPC | Evolved Packet |
| | Core |
| EPDCCH | enhanced |
| | PDCCH, enhanced |
| | Physical |
| | Downlink Control |
| | Cannel |
| EPRE | Energy per |
| | resource element |
| EPS | Evolved Packet |
| | System |
| EREG | enhanced REG, |
| | Channel |
| | enhanced |
| | resource |
| | element groups |
| ETSI | European |
| | Telecommunications |
| | Standards |
| | Institute |
| ETWS | Earthquake and |
| | Tsunami |
| | Warning |
| | System |
| eUICC | embedded UICC, |
| | embedded |
| | Universal |
| | Integrated Circuit |
| | Card |
| E-UTRA | Evolved |
| | UTRA |
| E-UTRAN | Evolved |
| | UTRAN |
| EV2X | Enhanced V2X |
| F1AP | F1 Application |
| | Protocol |
| F1-C | F1 Control plane |
| | interface |
| F1-U | F1 User plane |
| | interface |
| FACCH | Fast |
| | Associated Control |
| | CHannel |
| FACCH/F | Fast |
| | Associated Control |
| | Channel/Full rate |
| FACCH/H | Fast |
| | Associated Control |
| | Channel/Half rate |
| FACH | Forward Access |
| | Channel |
| FAUSCH | Fast |
| | Uplink Signalling |
| | Channel |
| FB | Functional Block |
| FBI | Feedback |
| | Information |
| FCC | Federal |
| | Communications |
| | Commission |
| FCCH | Frequency |
| | Correction |
| | CHannel |
| FDD | Frequency |
| | Division Duplex |
| FDM | Frequency |
| | Division |
| | Multiplex |
| FDMA | Frequency |
| | Division |
| | Multiple |
| | Access |
| FE | Front End |
| FEC | Forward Error |
| | Correction |
| FFS | For Further Study |
| FFT | Fast Fourier |
| | Transformation |
| feLAA | further enhanced |
| | Licensed Assisted |
| | Access, further |
| | enhanced LAA |
| FN | Frame Number |
| FPGA | Field- |
| | Programmable Gate |
| | Array |
| FR | Frequency Range |
| FQDN | Fully Qualified |
| | Domain Name |
| G-RNTI | GERAN |
| | Radio Network |
| | Temporary |
| | Identity |
| GERAN | GSM EDGE |
| | RAN, GSM EDGE |
| | Radio Access |
| | Network |
| GGSN | Gateway GPRS |
| | Support |
| | Node |
| | GLONASS |
| | GLObal'naya |
| | NAvigatsionnaya |
| | Sputnikovaya |
| | Sistema |
| | (Engl.: |
| | Global Navigation |
| | Satellite System) |
| gNB | Next Generation |
| | NodeB |
| gNB-CU | gNB- |
| | centralized unit, Next |
| | Generation |
| | NodeB |
| | centralized unit |
| gNB-DU | gNB- |
| | distributed unit, Next |
| | Generation |
| | NodeB |
| | distributed |
| | unit |
| GNSS | Global |
| | Navigation Satellite |
| | System |
| GPRS | General Packet |
| | Radio Service |
| GPSI | Generic |
| | Public Subscription |
| | Identifier |
| GSM | Global System |
| | for Mobile |
| | Communications, |
| | Groupe Spécial |
| | Mobile |
| GTP | GPRS Tunneling |
| | Protocol |
| GTP-UGPRS | Tunnelling |
| | Protocol for User |
| | Plane |
| GTS | Go To Sleep |
| | Signal (related to |
| | WUS) |
| GUMMEI | Globally |
| | Unique MME Identifier |
| GUTI | Globally Unique |
| | Temporary UE |
| | Identity |
| HARQ | Hybrid ARQ, |
| | Hybrid Automatic |
| | Repeat Request |
| HANDO | Handover |
| | HFN HyperFrame |
| | Number |
| HHO | Hard Handover |
| HLR | Home Location |
| | Register |
| HN | Home Network |
| HO | Handover |
| HPLMN | Home |
| | Public Land Mobile |
| | Network |
| HSDPA | High |
| | Speed Downlink |
| | Packet Access |
| HSN | Hopping |
| | Sequence Number |
| HSPA | High Speed |
| | Packet Access |
| HSS | Home Subscriber |
| | Server |
| HSUPA | High |
| | Speed Uplink Packet |
| | Access |
| HTTP | Hyper Text |
| | Transfer Protocol |
| HTTPS | Hyper |
| | Text Transfer Protocol |
| | Secure (https is |
| | 55 http/1.1 over |
| | SSL, i.e. port 443) |
| | I-Block |
| | Information |
| | Block |
| ICCID | Integrated Circuit |
| | Card Identification |
| IAB | Integrated Access |
| | and Backhaul |
| ICIC | Inter-Cell |
| | Interference |
| | Coordination |
| ID | Identity, identifier |
| IDFT | Inverse Discrete |
| | Fourier Transform |
| IE | Information |
| | element |
| IBE | In-Band Emission |
| IEEE | Institute of |
| | Electrical and |
| | Electronics |
| | Engineers |
| IEI | Information |
| | Element Identifier |
| IEIDL | Information |
| | Element Identifier |
| | Data Length |
| IETF | Internet |
| | Engineering Task |
| | Force |
| IF | Infrastructure |
| IIOT | Industrial Internet |
| | of Things |
| IM | Interference |
| | Measurement, |
| | Intermodulation, |
| IP | Multimedia |
| IMC | IMS Credentials |
| IMEI | International |
| | Mobile |
| | Equipment |
| | Identity |
| IMGI | International |
| | mobile group identity |
| IMPI | IP Multimedia |
| | Private Identity |
| IMPU | IP Multimedia |
| | PUblic identity |
| IMS | IP Multimedia |
| | Subsystem |
| IMSI | International |
| | Mobile Subscriber |
| | Identity |
| IoT | Internet of Things |
| IP | Internet Protocol |
| Ipsec | IP Security, |
| | Internet Protocol |
| | Security |
| IP-CAN | IP- |
| | Connectivity Access |
| | Network |
| IP-M | IP Multicast |
| IPv4 | Internet Protocol |
| | Version 4 |
| IPv6 | Internet Protocol |
| | Version 6 |
| IR | Infrared |
| IS | In Sync |
| IRP | Integration |
| | Reference Point |
| ISDN | Integrated |
| | Services Digital |
| | Network |
| ISIM | IM Services |
| | Identity Module |
| ISO | International |
| | Organisation for |
| | Standardisation |
| ISP | Internet Service |
| | Provider |
| IWF | Interworking- |
| | Function |
| I-WLAN | Interworking |
| | WLAN |
| | Constraint length |
| | of the convolutional |
| | code, USIM Individual |
| | key |
| kB | Kilobyte (1000 |
| | bytes) |
| kbps | kilo-bits per |
| | second |
| Kc | Ciphering key |
| Ki | Individual |
| | subscriber |
| | authentication |
| | key |
| KPI | Key Performance |
| | Indicator |
| KQI | Key Quality |
| | Indicator |
| KSI | Key Set Identifier |
| | ksps kilo-symbols per |
| | second |
| KVM | Kernel Virtual |
| | Machine |
| L1 | Layer 1 (physical |
| | layer) |
| L1-RSRP | Layer 1 |
| | reference signal |
| | received power |
| L2 | Layer 2 (data link |
| | layer) |
| L3 | Layer 3 (network |
| | layer) |
| LAA | Licensed Assisted |
| | Access |
| LAN | Local Area |
| | Network |
| LADN | Area Data Network |
| LBT | Listen Before |
| | Talk |
| LCM | LifeCycle |
| | Management |
| LCR | Low Chip Rate |
| LCS | Location Services |
| LCID | Logical |
| | Channel ID |
| LI | Layer Indicator |
| LLC | Logical Link |
| | Control, Low Layer |
| | Compatibility |
| LMF | Location |
| | Management Function |
| LOS | Line of |
| | Sight |
| LPLMN | Local |
| | PLMN |
| LPP | LTE Positioning |
| | Protocol |
| LSB | Least Significant |
| | Bit |
| LTE | Long Term |
| | Evolution |
| LWA | LTE-WLAN |
| | aggregation |
| LWIP | LTE/WLAN |
| | Radio Level |
| | Integration with |
| | IPsec Tunnel |
| LTE | Long Term |
| | Evolution |
| M2M | Machine-to- |
| | Machine |
| MAC | Medium Access |
| | Control (protocol |
| | layering context) |
| MAC | Message |
| | authentication code |
| | (security/encryption |
| | context) |
| MAC-A | MAC |
| | used for |
| | authentication |
| | and key agreement |
| | (TSG T WG3 context) |
| MAC-IMAC | used for |
| | data integrity of |
| | signalling messages |
| | (TSG T WG3 context) |
| MANO | Management and |
| | Orchestration |
| MBMS | Multimedia |
| | Broadcast and Multicast |
| | Service |
| MBSFN | Multimedia |
| | Broadcast multicast |
| | service Single Frequency |
| | Network |
| MCC | Mobile Country |
| | Code |
| MCG | Master Cell |
| | Group |
| MCOT | Maximum |
| | Channel |
| | Occupancy Time |
| MCS | Modulation and |
| | coding scheme |
| MDAF | Management |
| | Data Analytics |
| | Function |
| MDAS | Management |
| | Data Analytics |
| | Service |
| MDT | Minimization of |
| | Drive Tests |
| ME | Mobile |
| | Equipment |
| MeNB | master eNB |
| MER | Message Error |
| | Ratio |
| MGL | Measurement |
| | Gap Length |
| MGRP | Measurement |
| | Gap Repetition Period |
| MIB | Master |
| | Information Block, |
| | Management |
| | Information Base |
| MIMO | Multiple Input |
| | Multiple Output |
| MLC | Mobile Location |
| | Centre |
| MM | Mobility |
| | Management |
| MME | Mobility |
| | Management Entity |
| MN | Master Node |
| MNO | Mobile |
| | Network Operator |
| MO | Measurement |
| | Object, Mobile |
| | Originated |
| MPBCH | MTC |
| | Physical Broadcast |
| | CHannel |
| MPDCCH | MTC |
| | Physical Downlink |
| | Control CHannel |
| MPDSCH | MTC |
| | Physical Downlink |
| | Shared CHannel |
| MPRACH | MTC |
| | Physical Random |
| | Access CHannel |
| MPUSCH | MTC |
| | Physical Uplink Shared |
| | Channel |
| MPLS | MultiProtocol |
| | Label Switching |
| MS | Mobile Station |
| MSB | Most Significant |
| | Bit |
| MSC | Mobile Switching |
| | Centre |
| MSI | Minimum System |
| | Information, |
| MCH | Scheduling |
| | Information |
| MSID | Mobile Station |
| | Identifier |
| MSIN | Mobile Station |
| | Identification |
| | Number |
| MSISDN | Mobile |
| | Subscriber ISDN |
| | Number |
| MT | Mobile |
| | Terminated, Mobile |
| | Termination |
| MTC | Machine-Type |
| | Communications |
| | mMTCmassive MTC, |
| | massive Machine- |
| | Type Communications |
| MU-MIMO | Multi |
| | User MIMO |
| MWUS | MTC |
| | wake-up signal, MTC |
| | WUS |
| NACK | Negative |
| | Acknowledgement |
| NAI | Network Access |
| | Identifier |
| NAS | Non-Access |
| | Stratum, Non-Access |
| | Stratum layer |
| NCT | Network |
| | Connectivity Topology |
| NC-JT | Non- |
| | Coherent Joint |
| | Transmission |
| NEC | Network |
| | Capability Exposure |
| NE-DC | NR-E- |
| | UTRA Dual |
| | Connectivity |
| NEF | Network |
| | Exposure Function |
| NF | Network Function |
| NFP | Network |
| | Forwarding Path |
| NFPD | Network |
| | Forwarding Path |
| | Descriptor |
| NFV | Network |
| | Functions |
| | Virtualization |
| NFVI | NFV |
| | Infrastructure |
| NFVO | NFV Orchestrator |
| NG | Next Generation, |
| | Next Gen |
| NGEN-DC | NG-RAN |
| | E-UTRA-NR Dual |
| | Connectivity |
| NM | Network Manager |
| NMS | Network |
| | Management System |
| N-POP | Network Point of |
| | Presence |
| NMIB, N-MIB | Narrowband MIB |
| NPBCH | Narrowband |
| | Physical Broadcast |
| | CHannel |
| NPDCCH | Narrowband |
| | Physical Downlink |
| | Control CHannel |
| NPDSCH | Narrowband |
| | Physical Downlink |
| | Shared CHannel |
| NPRACH | Narrowband |
| | Physical Random |
| | Access CHannel |
| NPUSCH | Narrowband |
| | Physical Uplink |
| | Shared CHannel |
| NPSS | Narrowband |
| | Primary |
| | Synchronization |
| | Signal |
| NSSS | Narrowband |
| | Secondary |
| | Synchronization |
| | Signal |
| NR | New Radio, |
| | Neighbour Relation |
| NRF | NF Repository |
| | Function |
| NRS | Narrowband |
| | Reference Signal |
| NS | Network Service |
| NSA | Non-Standalone |
| | operation mode |
| NSD | Network Service |
| | Descriptor |
| NSR | Network Service |
| | Record |
| NSSAI | Network Slice |
| | Selection Assistance |
| | Information |
| S-NNSAI | Single- |
| | NSSAI |
| NSSF | Network Slice |
| | Selection Function |
| NW | Network |
| NWUS | Narrowband |
| | wake-up signal, |
| | Narrowband WUS |
| NZP | Non-Zero Power |
| O&M | Operation and |
| | Maintenance |
| ODU2 | Optical channel |
| | Data Unit-type 2 |
| OFDM | Orthogonal |
| | Frequency Division |
| | Multiplexing |
| OFDMA | Orthogonal |
| | Frequency Division |
| | Multiple Access |
| OOB | Out-of-band |
| OOS | Out of Sync |
| OPEX | OPerating |
| | EXpense |
| OSI | Other System |
| | Information |
| OSS | Operations |
| | Support System |
| OTA | over-the-air |
| PAPR | Peak-to-Average |
| | Power Ratio |
| PAR | Peak to Average |
| | Ratio |
| PBCH | Physical |
| | Broadcast Channel |
| PC | Power Control, |
| | Personal Computer |
| PCC | Primary |
| | Component Carrier, |
| | Primary CC |
| P-CSCF | Proxy |
| | CSCF |
| PCell | Primary Cell |
| PCI | Physical Cell ID, |
| | Physical Cell |
| | Identity |
| PCEF | Policy and |
| | Charging |
| | Enforcement |
| | Function |
| PCF | Policy Control |
| | Function |
| PCRF | Policy Control |
| | and Charging Rules |
| | Function |
| PDCP | Packet Data |
| | Convergence Protocol, |
| | Packet Data |
| | Convergence |
| | Protocol layer |
| PDCCH | Physical |
| | Downlink Control |
| | Channel |
| PDCP | Packet Data |
| | Convergence Protocol |
| PDN | Packet Data |
| | Network, Public |
| | Data Network |
| PDSCH | Physical |
| | Downlink Shared |
| | Channel |
| PDU | Protocol Data |
| | Unit |
| PEI | Permanent |
| | Equipment Identifiers |
| PFD | Packet Flow |
| | Description |
| P-GW | PDN Gateway |
| PHICH | Physical |
| | hybrid-ARQ indicator |
| | channel |
| PHY | Physical layer |
| PLMN | Public Land |
| | Mobile Network |
| PIN | Personal |
| | Identification Number |
| PM | Performance |
| | Measurement |
| PMI | Precoding Matrix |
| | Indicator |
| PNF | Physical Network |
| | Function |
| PNFD | Physical Network |
| | Function Descriptor |
| PNFR | Physical Network |
| | Function Record |
| POC | PTT over Cellular |
| | PP, |
| PTP | Point-to-Point |
| PPP | Point-to-Point |
| | Protocol |
| PRACH | Physical |
| | RACH |
| PRB | Physical resource |
| | block |
| PRG | Physical resource |
| | block group |
| ProSe | Proximity |
| | Services, |
| | Proximity-Based |
| | Service |
| PRS | Positioning |
| | Reference Signal |
| PRR | Packet Reception |
| | Radio |
| PS | Packet Services |
| PSBCH | Physical |
| | Sidelink Broadcast |
| | Channel |
| PSDCH | Physical |
| | Sidelink Downlink |
| | Channel |
| PSCCH | Physical |
| | Sidelink Control |
| | Channel |
| PSSCH | Physical |
| | Sidelink Shared |
| | Channel |
| PSFCH | physical |
| | sidelink feedback |
| | channel |
| PSCell | Primary SCell |
| PSS | Primary |
| | Synchronization |
| | Signal |
| PSTN | Public Switched |
| | Telephone Network |
| PT-RS | Phase-tracking |
| | reference signal |
| PTT | Push-to-Talk |
| PUCCH | Physical |
| | Uplink Control |
| | Channel |
| PUSCH | Physical |
| | Uplink Shared |
| | Channel |
| QAM | Quadrature |
| | Amplitude |
| | Modulation |
| QCI | QoS class of |
| | identifier |
| QCL | Quasi co-location |
| QFI | QOS Flow ID, |
| | QoS Flow Identifier |
| QOS | Quality of |
| | Service |
| QPSK | Quadrature |
| | (Quaternary) Phase |
| | Shift Keying |
| QZSS | Quasi-Zenith |
| | Satellite System |
| RA-RNTI | Random |
| | Access RNTI |
| RAB | Radio Access |
| | Bearer, Random |
| | Access Burst |
| RACH | Random Access |
| | Channel |
| RADIUS | Remote |
| | Authentication Dial In |
| | User Service |
| RAN | Radio Access |
| | Network |
| RAND | RANDom |
| | number (used for |
| | authentication) |
| RAR | Random Access |
| | Response |
| RAT | Radio Access |
| | Technology |
| RAU | Routing Area |
| | Update |
| RB | Resource block, |
| | Radio Bearer |
| RBG | Resource block |
| | group |
| REG | Resource Element |
| | Group |
| Rel | Release |
| REQ | REQuest |
| RF | Radio Frequency |
| RI | Rank Indicator |
| RIV | Resource |
| | indicator value |
| RL | Radio Link |
| RLC | Radio Link |
| | Control, Radio |
| | Link Control |
| | layer |
| RLC AM | RLC |
| | Acknowledged Mode |
| RLC UM | RLC |
| | Unacknowledged Mode |
| RLF | Radio Link |
| | Failure |
| RLM | Radio Link |
| | Monitoring |
| RLM-RS | Reference |
| | Signal for RLM |
| RM | Registration |
| | Management |
| RMC | Reference |
| | Measurement Channel |
| RMSI | Remaining MSI, |
| | Remaining Minimum |
| | System |
| | Information |
| RN | Relay Node |
| RNC | Radio Network |
| | Controller |
| RNL | Radio Network |
| | Layer |
| RNTI | Radio Network |
| | Temporary Identifier |
| ROHC | RObust Header |
| | Compression |
| RRC | Radio Resource |
| | Control, Radio |
| | Resource Control |
| | layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal |
| | Time difference |
| RTP | Real Time |
| | Protocol |
| RTS | Ready-To-Send |
| RTT | Round Trip Time |
| Rx | Reception, |
| | Receiving, Receiver |
| S1AP | S1 Application |
| | Protocol |
| S1-MME | S1 for the |
| | control plane |
| S1-U | S1 for the |
| | user |
| | plane |
| S-CSCF | serving |
| | CSCF |
| S-GW | Serving Gateway |
| S-RNTI | SRNC |
| | Radio Network |
| | Temporary |
| | Identity |
| S-TMSI | SAE |
| | Temporary Mobile |
| | Station Identifier |
| SA | Standalone |
| | operation mode |
| SAE | System |
| | Architecture Evolution |
| SAP | Service Access |
| | Point |
| SAPD | Service Access |
| | Point Descriptor |
| SAPI | Service Access |
| | Point Identifier |
| SCC | Secondary |
| | Component Carrier, |
| | Secondary CC |
| | SCell Secondary Cell |
| SCEF | Service |
| | Capability Exposure |
| | Function |
| SC-FDMA | Single |
| | Carrier Frequency |
| | Access |
| SCG | Secondary Cell |
| | Group |
| SCM | Security Context |
| | Management |
| SCS | Subcarrier |
| | Spacing |
| SCTP | Stream Control |
| | Transmission |
| | Protocol |
| SDAP | Service Data |
| | Adaptation Protocol, |
| | Service Data |
| | Adaptation |
| | Protocol layer |
| SDL | Supplementary |
| | Downlink |
| SDNF | Structured Data |
| | Storage Network |
| | Function |
| SDP | Session |
| | Description Protocol |
| SDSF | Structured Data |
| | Storage Function |
| SDT | Small Data |
| | Transmission |
| SDU | Service Data Unit |
| SEAF | Security Anchor |
| | Function |
| SeNB | secondary eNB |
| SEPP | Security Edge |
| | Protection Proxy |
| SFI | Slot format |
| | indication |
| SFTD | Space-Frequency |
| | Time Diversity, SFN |
| | and frame timing |
| | difference |
| SFN | System Frame |
| | Number |
| SgNB | Secondary gNB |
| SGSN | Serving GPRS |
| | Support Node |
| S-GW | Serving Gateway |
| | SI System |
| | Information |
| SI-RNTI | System |
| | Information RNTI |
| SIB | System |
| | Information Block |
| SIM | Subscriber |
| | Identity Module |
| SIP | Session Initiated |
| | Protocol |
| SiP | System in |
| | Package |
| SL | Sidelink |
| SLA | Service Level |
| | Agreement |
| SM | Session |
| | Management |
| SMF | Session |
| | Management Function |
| SMS | Short Message |
| | Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| SP-CSI-RNTI | Semi- |
| | Persistent CSI RNTI |
| SPS | Semi-Persistent |
| | Scheduling |
| SQN | Sequence number |
| SR | Scheduling |
| | Request |
| SRB | Signalling Radio |
| | Bearer |
| SRS | Sounding |
| | Reference Signal |
| SS | Synchronization |
| | Signal |
| SSB | Synchronization |
| | Signal Block |
| SSID | Service Set |
| | Identifier |
| SS/PBCH | Block |
| | SSBRI SS/PBCH Block |
| | Resource Indicator, |
| | Synchronization |
| | Signal Block |
| | Resource Indicator |
| SSC | Session and |
| | Service Continuity |
| SS-RSRP | Synchronization |
| | Signal based Reference |
| | Signal Received |
| | Power |
| SS-RSRQ | Synchronization |
| | Signal based Reference |
| | Signal Received |
| | Quality |
| SS-SINR | Synchronization |
| | Signal based Signal to |
| | Noise and Interference |
| | Ratio |
| SSS | Secondary |
| | Synchronization |
| | Signal |
| SSSG | Search Space Set |
| | Group |
| SSSIF | Search Space Set |
| | Indicator |
| SST | Slice/Service |
| | Types |
| SU-MIMO | Single |
| | User MIMO |
| SUL | Supplementary |
| | Uplink |
| TA | Timing Advance, |
| | Tracking Area |
| TAC | Tracking Area |
| | Code |
| TAG | Timing Advance |
| | Group |
| TAI | Tracking |
| | Area Identity |
| TAU | Tracking Area |
| | Update |
| TB | Transport Block |
| TBS | Transport Block |
| | Size |
| TBD | To Be Defined |
| TCI | Transmission |
| | Configuration Indicator |
| TCP | Transmission |
| | Communication |
| | Protocol |
| TDD | Time Division |
| | Duplex |
| TDM | Time Division |
| | Multiplexing |
| TDMA | Time Division |
| | Multiple Access |
| TE | Terminal |
| | Equipment |
| TEID | Tunnel End Point |
| | Identifier |
| TFT | Traffic Flow |
| | Template |
| TMSI | Temporary |
| | Mobile Subscriber |
| | Identity |
| TNL | Transport |
| | Network Layer |
| TPC | Transmit Power |
| | Control |
| TPMI | Transmitted |
| | Precoding Matrix |
| | Indicator |
| TR | Technical Report |
| | TRP, TRxP |
| | Transmission |
| | Reception Point |
| TRS | Tracking |
| | Reference Signal |
| TRx | Transceiver |
| TS | Technical |
| | Specifications, |
| | Technical |
| | Standard |
| TTI | Transmission |
| | Time Interval |
| Tx | Transmission, |
| | Transmitting, |
| | Transmitter |
| U-RNTI | UTRAN |
| | Radio Network |
| | Temporary |
| | Identity |
| UART | Universal |
| | Asynchronous |
| | Receiver and |
| | Transmitter |
| UCI | Uplink Control |
| | Information |
| UE | User Equipment |
| UDM | Unified Data |
| | Management |
| UDP | User Datagram |
| | Protocol |
| UDSF | Unstructured |
| | Data Storage Network |
| | Function |
| UICC | Universal |
| | Integrated Circuit |
| | Card |
| UL | Uplink |
| UM | Unacknowledged |
| | Mode |
| UML | Unified |
| | Modelling Language |
| | UMTS Universal Mobile |
| | Telecommunications |
| | System |
| UP | User Plane |
| UPF | User Plane |
| | Function |
| URI | Uniform |
| | Resource Identifier |
| URL | Uniform |
| | Resource Locator |
| URLLC | Ultra- |
| | Reliable and Low |
| | Latency |
| USB | Universal Serial |
| | Bus |
| USIM | Universal |
| | Subscriber Identity |
| | Module |
| USS | UE-specific |
| | search space |
| UTRA | UMTS Terrestrial |
| | Radio Access |
| UTRAN | Universal |
| | Terrestrial Radio |
| | Access Network |
| UwPTS | Uplink |
| | Pilot Time Slot |
| V2I | Vehicle-to- |
| | Infrastruction |
| V2P | Vehicle-to- |
| | Pedestrian |
| V2V | Vehicle-to- |
| | Vehicle |
| V2X | Vehicle-to- |
| | everything |
| VIM | Virtualized |
| | Infrastructure Manager |
| VL | Virtual Link, |
| VLAN | Virtual LAN, |
| | Virtual Local Area |
| | Network |
| VM | Virtual Machine |
| VNF | Virtualized |
| | Network |
| | Function |
| VNFFG | VNF |
| | Forwarding Graph |
| VNFFGD | VNF |
| | Forwarding Graph |
| | Descriptor |
| VNFM | VNF Manager |
| VOIP | Voice-over-IP, |
| | Voice-over- |
| | Internet |
| | Protocol |
| VPLMN | Visited |
| | Public Land Mobile |
| | Network |
| VPN | Virtual Private |
| | Network |
| VRB | Virtual Resource |
| | Block |
| WiMAX | Worldwide |
| | Interoperability |
| | for |
| | Microwave Access |
| WLAN | Wireless Local |
| | Area Network |
| WMAN | Wireless |
| | Metropolitan Area |
| | Network |
| WPAN | Wireless Personal |
| | Area Network |
| X2-C | X2-Control plane |
| X2-U | X2-User plane |
| XML | extensible |
| | Markup |
| | Language |
| XRES | EXpected user |
| | RESponse |
| XOR | exclusive OR |
| ZC | Zadoff-Chu |
| ZP | Zero Power |

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), descision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1.-20. (canceled)

21. A user equipment (UE) comprising:
one or more processors; and
one or more non-transitory computer-readable media comprising instructions that, upon execution of the instructions by the one or more processors, are to cause the UE to:
identify that the UE is to transmit a sidelink (SL) transmission in a slot that includes two candidate starting symbols for the SL transmission;
identify, based on the identification that the slot includes two candidate starting symbols, a reference symbol length;
identify, based on the reference symbol length, a transport block size (TBS); and
transmit the SL transmission in the slot based on the TBS.

22. The UE of claim 21, wherein the instructions are further to:
identify, based on a characteristic of the SL channel, the reference symbol length; and
transmit an indication of the reference symbol length.

23. The UE of claim 21, wherein the reference symbol length is identified based on a first starting symbol of the two candidate starting symbols.

24. The UE of claim 21, wherein the reference symbol length is identified based on a second starting symbol of the two candidate starting symbols.

25. The UE of claim 21, wherein the reference symbol length is identified based on a pre-configured reference symbol length.

26. The UE of claim 21, wherein the SL transmission is a physical SL control channel (PSCCH) transmission or a physical SL shared channel (PSSCH) transmission.

27. The UE of claim 21, wherein a first starting symbol of the two candidate starting symbols is a symbol from the set of symbols {#0, #1, #2, #3, #4, #5, #6} of the slot.

28. The UE of claim 21, wherein a second starting symbol of the two candidate starting symbols is a symbol from the set of symbols {#3, #4, #5, #6, #7} of the slot.

29. The UE of claim 21, wherein a first starting symbol of the two candidate starting symbols is symbol #0 of the slot.

30. An electronic device for use in a user equipment (UE), wherein the electronic device comprises:
memory to store information related to physical resources of a frequency bandwidth in an unlicensed spectrum; and
one or more processors configured to:
allocate frequency resources of a single sub-channel of a plurality of sub-channels for transmission of a new radio (NR) sidelink (SL) transmission;
interleave the plurality of sub-channels to form interleaved sub-channels;
map the interleaved sub-channels to the physical resources; and
facilitate transmission, by the UE based on the interleaved plurality of sub-channels, of the SL transmission in the unlicensed spectrum on one or more of the physical resources of the frequency bandwidth.

31. The electronic device of claim 30, wherein the SL transmission is a physical SL control channel (PSCCH) transmission.

32. The electronic device of claim 30, wherein the SL transmission occupies two consecutive symbols or three consecutive symbols of the physical resources.

33. The electronic device of claim 30, wherein the sub-channel is a lowest sub-channel of the plurality of sub-channels.

34. The electronic device of claim 30, wherein the interleaving is resource block (RB)-based interleaving.

35. The electronic device of claim 30, wherein the SL transmission is to be transmitted over a plurality of slots.

36. One or more non-transitory computer-readable media comprising instructions that, upon execution of the instructions by one or more processors of a user equipment (UE), are to cause the UE to:
identify physical resources of a frequency bandwidth in the unlicensed spectrum;
allocate frequency resources of a single sub-channel of a plurality of sub-channels for transmission of a new radio (NR) physical sidelink (SL) transmission;
interleave, via resource block (RB)-based interleaving, the plurality of sub-channels to form interleaved sub-channels;
map the interleaved sub-channels to the physical resources; and
transmit, based on the interleaved plurality of sub-channels, the physical SL transmission in the unlicensed spectrum on one or more of the physical resources of the frequency bandwidth.

37. The electronic device of claim 36, wherein the physical SL transmission occupies two consecutive symbols or three consecutive symbols of the physical resources.

38. The electronic device of claim 36, wherein the sub-channel is a lowest sub-channel of the plurality of sub-channels.

39. The electronic device of claim 36, wherein the physical SL transmission is to be transmitted over a plurality of slots.

40. The electronic device of claim 39, wherein the physical SL transmission is a physical SL control channel (PSCCH) transmission or a physical SL shared channel (PSSCH) transmission.
